(19) United States
(12) Patent Application Publication
(10) Pub. No.: US 2014/0068045 A1
(43) Pub. Date: Mar. 6, 2014

(54) NETWORK SYSTEM AND VIRTUAL NODE MIGRATION METHOD

(71) Applicant: Hitachi, Ltd., Tokyo (JP)

(72) Inventors: Toshiaki TARUI, Sagamihara (JP); Yasusi KANADA, Tokyo (JP); Yasushi KASUGAI, Ninomiya (JP)

(73) Assignee: Hitachi, Ltd., Tokyo (JP)

(21) Appl. No.: 13/961,209

(22) Filed: Aug. 7, 2013

(30) Foreign Application Priority Data
Aug. 29, 2012 (JP) 2012-188316

(51) Int. Cl. H04L 12/24

(52) U.S. Cl. CPC H04L 41/02
USPC 709/223

(57) ABSTRACT

A disclosed example is a network system including physical nodes. The network system provides a virtual network system including virtual nodes allocated computer resources of the physical nodes. In a case where the network system performs migration of a first virtual node for executing service using computer resources of a first physical node to a second physical node, the network system creates the communication paths for connecting the second physical node and the neighboring physical nodes on the physical links, starts the service executed by the first virtual node using the computer resources secured by the second physical node, switches communication paths to the created communication paths for switching the virtual links.

### CLAIM OF PRIORITY

The present application claims priority from Japanese patent application JP2012-188316 filed on Aug. 29, 2012, the content of which is hereby incorporated by reference into this application.

### BACKGROUND

This invention relates to a method for migration of a virtual node in a virtual network.

In recent years, various services, such as the Internet services, telephone services, mobile services, and enterprise network services, are provided via networks. To create networks for such different services and to provide functions required for the services, virtual network technology is employed that creates a plurality of virtual networks (slices) on a physical network.

In order to create a virtual network, nodes forming the physical network to be the infrastructure are required to have a function to perform processing specific to the virtual network.

Since this function is different depending on the slice, it is common to implement the function by executing a program (a program for a general-purpose server or network processor).

In the virtual network technology, the virtual network configuration is separated from the physical network configuration. Accordingly, a node (virtual node) for a virtual network can be allocated to any physical node if computer resources (such as a CPU, a memory, and a network bandwidth) and performance (such as network latency) required for the virtual node can be secured. The same applies to a link for a virtual network; a virtual link can be freely configured with physical links.

A virtual node can be created with designation of a specific physical node and physical links based on a demand of the administrator of the virtual network.

In the meanwhile, the virtual network technology requires that the addresses and the packet configuration in the virtual network do not affect those in the physical network.

For this purpose, it is required to separate the virtual network from the physical network using a VLAN and separate packets in the virtual network from packets in the physical network by encapsulating the packets using GRE and Mac-in-Mac.

The encapsulation enables virtual network communication in a free packet format, which does not depend on the existing IP communication.

To create a virtual network covering a wide area, the virtual network may have to be created from networks under different management systems. For example, a virtual network may be created from networks of different communication providers or networks in a plurality of countries.

In the following description, a management unit for network in physical networks is referred to as domain and creating a virtual network ranging in a plurality of domains is referred to as federation.

Federation is to create a virtual network demanded by the administrator of the virtual network to provide service under cooperation of the management servers of a plurality of domains, like in the case of a single domain.

As described above, virtual nodes can be freely allocated to physical nodes; however, they need to be reallocated because of some reason. In other words, a demand for migration of a virtual node is generated.

For example, in the case of increasing the amount of computer resources allocated to a virtual node, if the physical node does not have enough computer resources, the virtual node needs to be transferred to another physical node having a sufficient amount of computer resources. Besides, the destination physical node should be close to the source node in the network.

The migration of a virtual node is desirable to be seamless in the virtual network, which means the physical node allocated the virtual node should be changed without changing the configuration of the virtual network.

Furthermore, the service of the virtual network should be kept provided during the execution of migration. That is to say, migration of a node should be completed without interruption of the service when seeing from the service users of the virtual network. Some techniques for live migration of a virtual machine (VM) between servers have been commercialized; however, they generate a very short interruption (about 0.5 seconds) of operation of the VM when transferring the VM. In application of such a technique to a node of a virtual network, interruption of network communication is unacceptable. Accordingly, migration of a virtual node should be achieved without using the VM live migration.

### SUMMARY

Pisa, P., and seven others, “OpenFlow and Xen-based Virtual Network Migration”, Wireless in Developing Countries and Networks of the Future, volume 327 of IFIP Advances in Information and Communication Technology, Springer Boston, pp. 170-181 discloses, in FIG. 3, a migration method in a virtual network configured with OpenFlow switches. To keep communication in the virtual network during the migration, OpenFlow switches, where a flow (in one direction) goes through, are configured in accordance with the following three steps to perform migration:

(1) Add the definition of the flow to go through a new node to the newly added node and the node where the flow from the new node meets the existing path;

(2) Change the definition of the flow into the definition of the new flow in the node where the existing path branches to the new node; and

(3) Delete the definition of the flow in the old node where the flow no longer goes through.

During transmission of a flow going through OpenFlow switches, the foregoing step (2) that changes the path information enables the flow to go along a new path without interruption of transmission.

However, this existing technique is based on the condition that the virtual nodes are allocated to OpenFlow switches. Accordingly, it is difficult to apply this existing technique to virtual nodes implemented by a program running on a general-purpose server or a network processor.

Furthermore, in this existing technique, the OpenFlow switches are controlled by a single controller, which means this technique is based on a single domain network. Accordingly, it cannot be applied to migration between domains.

This invention has been accomplished in view of the foregoing problems. That is to say, an object of this invention is to provide a network system that, in a virtual network ranging in a plurality of domains, allows migration of changing the allocation of a virtual node quickly and without interruption of the service being executed by the virtual node.

An aspect of this invention is a network system including physical nodes having computer resources. The physical nodes are connected to one another via physical links. The network system provides a virtual network system including virtual nodes allocated computer resources of the physical nodes to execute predetermined service. The network system including: a network management unit for managing the virtual nodes; at least one node management unit for managing the physical nodes; and at least one link management unit for managing connections of the physical links connecting the physical nodes and connections of virtual links connecting the virtual nodes. The network management unit holds mapping information indicating correspondence relations between the virtual nodes and the physical nodes allocating the computer resources to the virtual nodes and virtual node management information for managing the virtual links. The at least one link management unit holds path configuration information for managing connection states of the virtual links. In a case where the network system performs migration of a first virtual node for executing service using computer resources of a first physical node to a second physical node, the network management unit sends the second physical node an instruction to secure computer resources to be allocated to the first virtual node. The network management unit identifies neighboring physical nodes allocating computer resources to neighboring virtual nodes connected to the first virtual node via virtual links in the virtual network. The network management unit sends the at least one link management unit an instruction to create communication paths for implementing virtual links for connecting the first virtual node and the neighboring virtual nodes on physical links connecting the second physical node and the neighboring physical nodes. The at least one link management unit creates the communication paths for connecting the second physical node and the neighboring physical nodes on the physical links based on the instruction to create the communication paths. The at least one node management unit starts the service executed by the first virtual node using the computer resources secured by the second physical node. The network management unit sends the at least one link management unit an instruction to switch the virtual links. The at least one link management unit switches communication paths to the created communication paths for switching the virtual links.

According to an aspect of this invention, the service of a virtual node is started in a physical node of a migration destination and communication paths to be allocated virtual links are prepared between the physical node of the migration destination and the physical nodes to execute the service of neighboring virtual nodes, so that migration of the virtual node to a different physical node can be performed quickly without interruption of the service being executed by the virtual node.

### BRIEF DESCRIPTION OF THE DRAWINGS

FIG. 1 is an explanatory diagram illustrating a configuration example of a network system in the embodiments of this invention;

FIG. 2 is an explanatory diagram illustrating a configuration example of a virtual network (slice) in Embodiment 1 of this invention;

FIG. 3 is an explanatory diagram illustrating a configuration example of a physical network in Embodiment 1 of this invention;

FIG. 4 is an explanatory diagram illustrating an example of mapping information in Embodiment 1 of this invention;

FIG. 5 is an explanatory diagram illustrating an example of virtual node management information in Embodiment 1 of this invention;

FIG. 6 is an explanatory diagram illustrating a configuration example of a physical node in Embodiment 1 of this invention;

FIG. 7A is an explanatory diagram illustrating an example of packet format in Embodiment 1 of this invention;

FIG. 7B is an explanatory diagram illustrating another example of packet format in Embodiment 1 of this invention;

FIG. 8 is an explanatory diagram illustrating an example of path configuration information in Embodiment 1 of this invention;

FIG. 9A is a sequence diagram illustrating a processing flow of migration in Embodiment 1 of this invention;

FIG. 9B is a sequence diagram illustrating a processing flow of migration in Embodiment 1 of this invention;

FIG. 10A is an explanatory diagram illustrating a state within a domain 15 during the migration in Embodiment 1 of this invention;

FIG. 10B is an explanatory diagram illustrating a state within a domain 15 during the migration in Embodiment 1 of this invention;

FIG. 10C is an explanatory diagram illustrating a state within a domain 15 during the migration in Embodiment 1 of this invention;

FIG. 11A is an explanatory diagram illustrating an example of path configuration information in Embodiment 1 of this invention;

FIG. 11B is an explanatory diagram illustrating an example of path configuration information in Embodiment 1 of this invention;

FIG. 12A is an explanatory diagram illustrating a connection state of communication paths in a GRE converter in Embodiment 1 of this invention;

FIG. 12B is an explanatory diagram illustrating a connection state of communication paths in a GRE converter in Embodiment 1 of this invention;

FIG. 13 is an explanatory diagram illustrating a configuration example of a physical network in Embodiment 2 of this invention;

FIG. 14A is a sequence diagram illustrating a processing flow of migration in Embodiment 2 of this invention;

FIG. 14B is a sequence diagram illustrating a processing flow of migration in Embodiment 2 of this invention;

FIG. 15A is an explanatory diagram illustrating a state within a domain 15 during the migration in Embodiment 2 of this invention;

FIG. 15B is an explanatory diagram illustrating a state within a domain 15 during the migration in Embodiment 2 of this invention;

FIG. 15C is an explanatory diagram illustrating a state within a domain 15 during the migration in Embodiment 2 of this invention;

FIG. 16A is a sequence diagram illustrating a processing flow of migration in Embodiment 3 of this invention; and

FIG. 16B is a sequence diagram illustrating a processing flow of migration in Embodiment 3 of this invention.

### DETAILED DESCRIPTION OF THE EMBODIMENTS

First, a configuration example of a network system to be used as the basis of this invention is described.

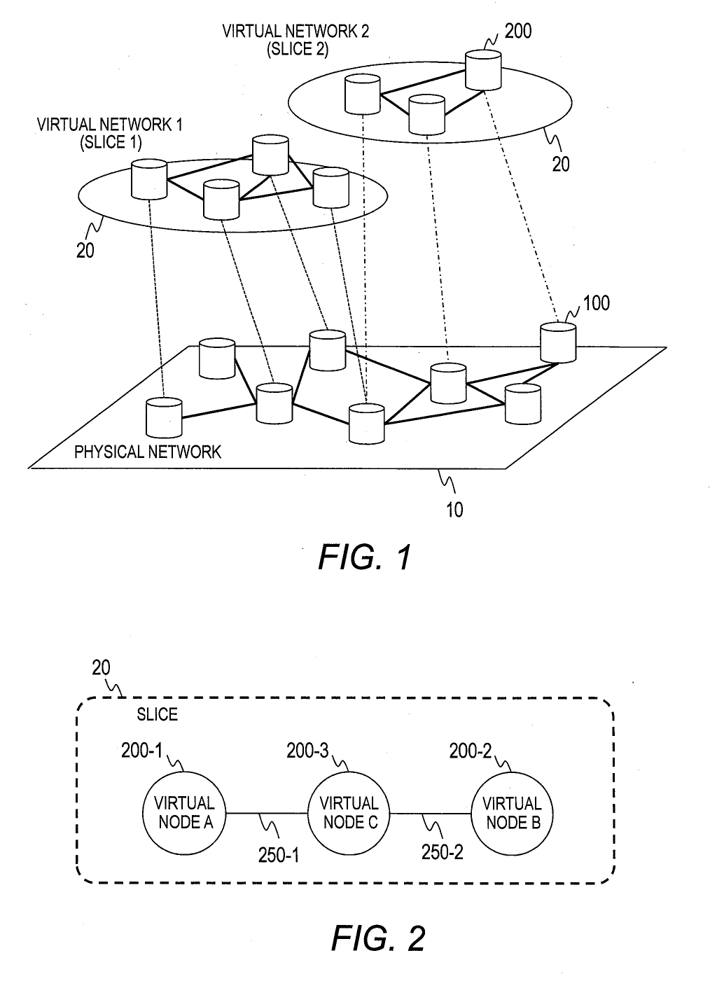

FIG. 1 is an explanatory diagram illustrating a configuration example of a network system in the embodiments of this invention.

In this invention, a plurality of different virtual networks 20 are created on a physical network 10.

The physical network 10 is composed of a plurality of physical nodes 100, which are connected via specific network lines.

This invention is not limited to the type of the network; any of WAN, LAN, and SAN, or other network may be used. This invention is not limited to the connection means either, which could be wired or wireless.

A virtual network 20 is composed of a plurality of virtual nodes 200, which are connected to one another via virtual network lines. The virtual nodes 200 execute predetermined service in the virtual network 20.

A virtual node 200 is implemented using computer resources of a physical node 100. Accordingly, one physical node 100 can provide virtual nodes 200 of different virtual networks 20.

The virtual networks 20 may be networks using different communication protocols.

Under the above-described scheme, independent networks can be freely created on a physical network 10. Moreover, effective utilization of existing computer resources lowers the introduction cost.

In this description, a virtual network is also referred to as slice.

### Embodiment 1

FIG. 2 is an explanatory diagram illustrating a configuration example of a virtual network (slice) 20 in Embodiment 1 of this invention.

In this embodiment, the slice 20 is composed of a virtual node A (200-1), a virtual node B (200-2), and a virtual node C (200-3). The virtual nodes A (200-1) and C (200-3) are connected via a virtual link 250-1; the virtual nodes B (200-2) and C (200-3) are connected via a virtual link 250-2.

In the following explanation, the virtual node C (200-3) is assumed to be a virtual node to be the subject of migration. For simplicity of explanation, FIG. 2 shows a virtual network (slice) 20 with a simple topology; however, the processing described hereinafter can be performed in a virtual network (slice) 20 with a more complex topology.

### (System Configuration)

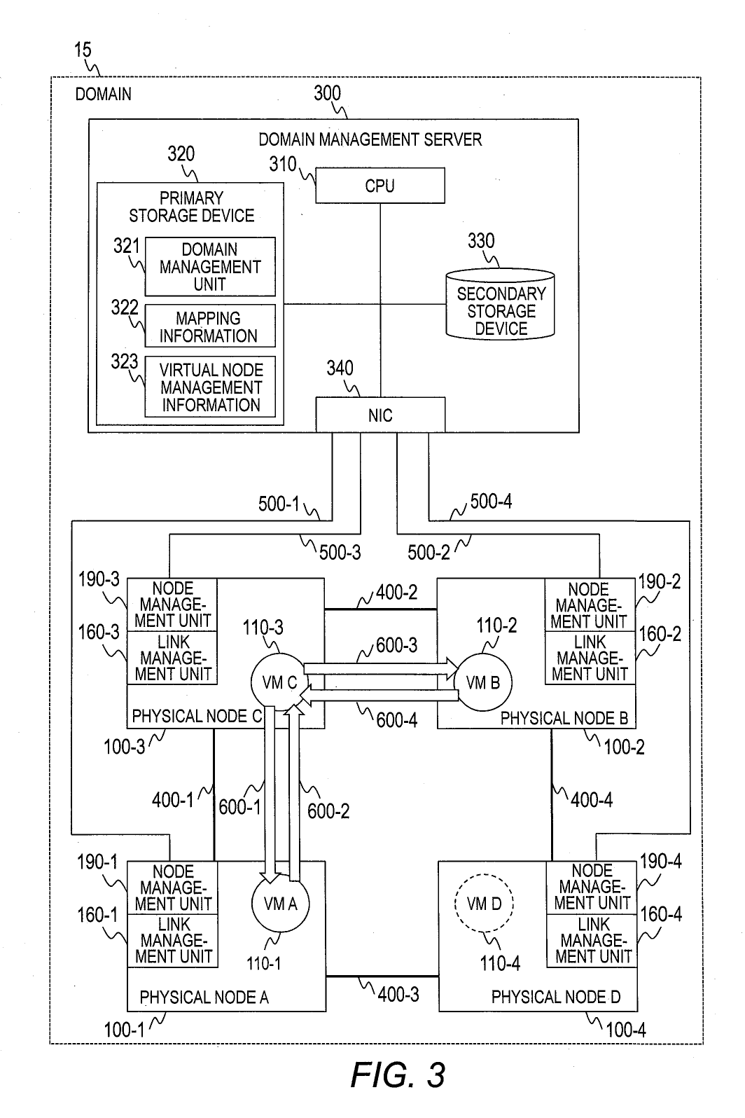

FIG. 3 is an explanatory diagram illustrating a configuration example of the physical network 10 in Embodiment 1 of this invention.

Embodiment 1 is described using a physical network 10 under a single domain 15 by way of example.

The domain 15 forming the physical network 10 includes a domain management server 300 and a plurality of physical nodes 100. This embodiment is based on the assumption that the slice 20 shown in FIG. 2 is provided using physical nodes 100 in the domain 15.

The domain management server 300 is a computer for managing the physical nodes 100 in the domain 15. The domain management server 300 includes a CPU 310, a primary storage device 320, a secondary storage device 330, and an NIC 340.

The CPU 310 executes programs stored in the primary storage device 320. The CPU 310 executes the programs to perform functions of the domain management server 300. The domain management server 300 may have a plurality of CPUs 310.

The primary storage device 320 stores programs to be executed by the CPU 310 and information required to execute the programs. An example of the primary storage device 320 is a memory.

The primary storage device 320 stores a program (not shown) for implementing a domain management unit 321. The primary storage device 320 also stores mapping information 322 and virtual node management information 323 for the information to be used by the domain management unit 321.

The domain management unit 321 manages the physical nodes 100 and the virtual nodes 200. In this embodiment, migration of a virtual node 200 is executed by the domain management unit 321.

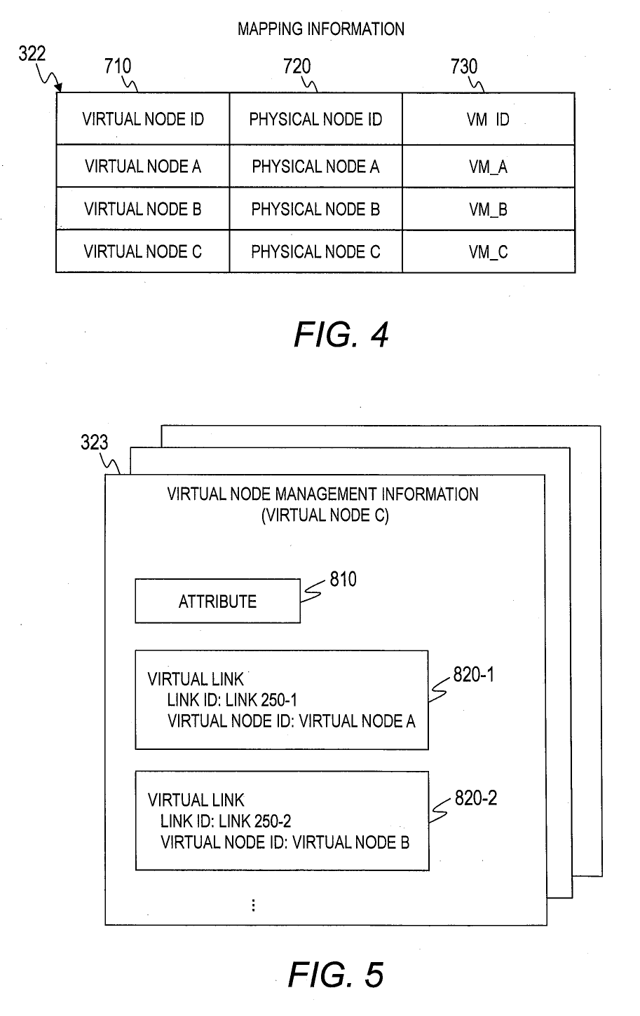

The mapping information 322 is information for managing correspondence relations between the physical nodes 100 in the domain 15 and the virtual nodes 200. The details of the mapping information 322 will be described later using FIG. 4. The virtual node management information 323 is configuration information for virtual nodes 200. The details of the virtual node management information 323 will be described later using FIG. 5.

The virtual node management information 323 is held by each physical node 100; the domain management server 300 can acquire the virtual node management information 323 from each physical node 100 in the domain 15.

The secondary storage device 330 stores a variety of data. Examples of the secondary storage device 330 are an HDD (Hard Disk Drive) and an SSD (Solid State Drive).

The program for implementing the domain management unit 321, the mapping information 322, and the virtual node management information 323 may be held in the secondary storage device 330. In this case, the CPU 310 retrieves them from the secondary storage device 330 to load the retrieved program and information to the primary storage device 320.

The NIC 340 is an interface for connecting the domain management server 300 to other nodes via network lines. In this embodiment, the domain management server 300 is connected to the physical nodes 100 via physical links 500-1, 500-2, 500-3, and 500-4 connected from the NIC 340. More specifically, the domain management server 300 is connected so as to be able to communicate with node management units 190 of the physical nodes 100 via the physical links 500.

The domain management server 300 may further include a management interface to connect to the node management units 190 of the physical nodes 100.

A physical node 100 provides a virtual node 200 included in the slice 20 with computer resources. The physical nodes 100 are connected to one another via physical links 400. Specifically, the physical node A (100-1) and the physical node C (100-3) are connected via a physical link 400-1; the physical node C (100-3) and the physical node B (100-2) are connected via the physical link 400-2; the physical node A (100-1) and the physical node D (100-4) are connected via a physical link 400-3; and the physical node B (100-2) and the physical node D (100-4) are connected via a physical link 400-4.

Each virtual node 200 is allocated to one of the physical nodes 100. In this embodiment, the virtual node A (200-1) is allocated to the physical node A (100-1); the virtual node B (200-2) is allocated to the physical node B (100-2); and the virtual node C (200-3) is allocated to the physical node C (100-3).

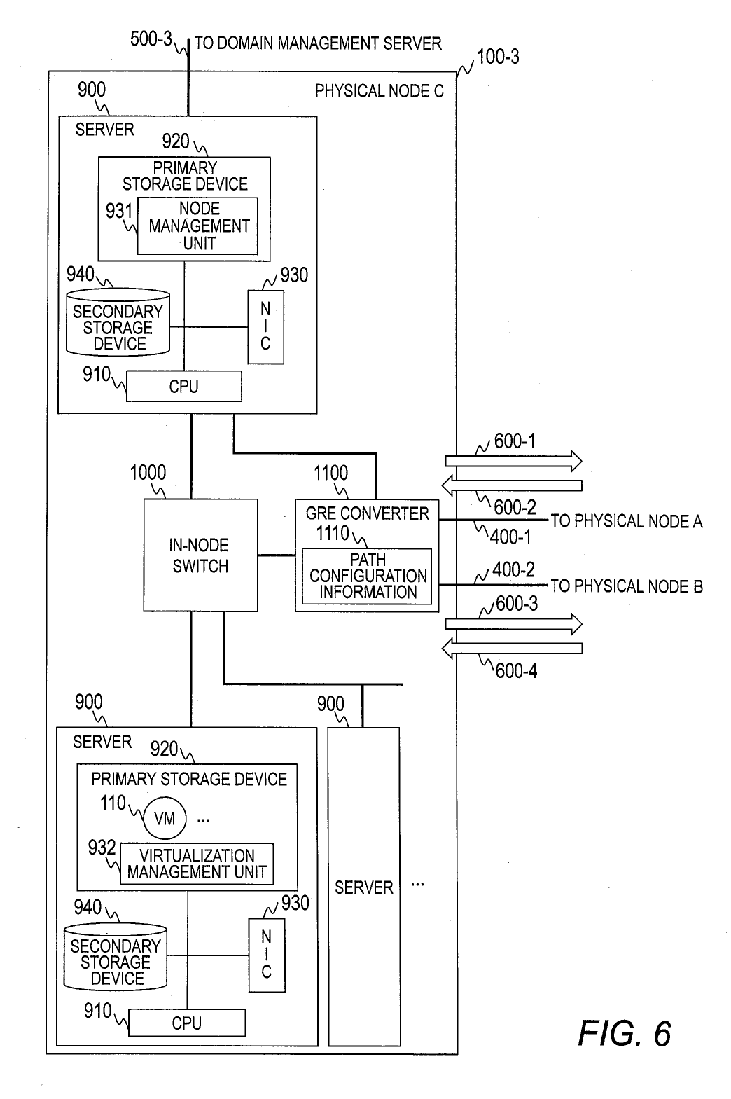

Each physical node 100 includes a link management unit 160 and a node management unit 190. The link management unit 160 manages physical links 400 connecting physical nodes 100 and virtual links 250. The node management unit 190 manages the entirety of the physical node 100. The physical node 100 also includes a virtualization management unit (refer to FIG. 6) for implementing a virtual machine (VM) 110.

In this embodiment, a VM 110 provides functions to implement a virtual node 200. Specifically, the VM 110 provides programmable functions for the virtual node 200. For example, the VM 110 executes a program to implement the function to convert the communication protocol.

In this embodiment, the VM_A (110-1) provides the functions of the virtual node A (200-1); the VM_B (110-2) provides the functions of the virtual node B (200-2); and the VM_C (110-3) provides the functions of the virtual node C (200-3).

In this embodiment, a VM 110 provides the functions of a virtual node 200; however, this invention is not limited to this. For example, the function of the virtual node 200 may be provided using the network processor, a GPU, or an FPGA.

In a physical link 400 connecting physical nodes 100 allocated virtual nodes 200, GRE tunnels 600 are created to implement a virtual link 250. This invention is not limited to this scheme implementing the virtual link 250 using the GRE tunnels 600. For example, the virtual link 250 can be implemented using a Mac-in-Mac or a VLAN.

Specifically, GRE tunnels 600-1 and 600-2 for providing the virtual link 250-1 are created in the physical link 400-1 and GRE tunnels 600-3 and 600-3 for providing the virtual link 250-2 are created in the physical link 400-2.

One GRE tunnel 600 supports unidirectional communication. For this reason, two GRE tunnels 600 are created in this embodiment to support bidirectional communication between virtual nodes 200.

FIG. 4 is an explanatory diagram illustrating an example of the mapping information 322 in Embodiment 1 of this invention.

The mapping information 322 stores information indicating correspondence relations between the virtual nodes 200 and the physical nodes 100 running the VMs 110 for providing the functions of the virtual nodes 200. Specifically, the mapping information 322 includes virtual node IDs 710, physical node IDs 720, and VM IDs 730. The mapping information 322 may include other information.

A virtual node ID 710 stores an identifier to uniquely identify a virtual node 200. A physical node ID 720 stores an identifier to uniquely identify a physical node 100. A VM ID 730 stores an identifier to uniquely identify a VM 110.

FIG. 5 is an explanatory diagram illustrating an example of the virtual node management information 323 in Embodiment 1 of this invention.

The virtual node management information 323 stores a variety of information to manage a virtual node 200 allocated to a physical node 100. In this embodiment, the virtual node management information 323 is in the XML format and a piece of virtual node management information 323 is for a single virtual node 200. In typical, pieces of virtual node management information 323 are for a physical node 100.

The virtual node management information 323 includes an attribute 810 and virtual link information 820. The virtual node management information 323 may include other information.

The attribute 810 stores information indicating the attribute of the virtual node 200, for example, identification information on the programs to be executed on the virtual node 200.

The virtual link information 820 stores information on the virtual links 250 connected to the virtual node 200 allocated to the physical node 100. For example, a piece of virtual link information 820 stores identification information on one of such virtual links 250 and identification information on the other virtual node 200 connected via the virtual link 250.

The example of FIG. 5 shows the virtual node management information 323 on the virtual node C (200-3). This virtual node management information 323 includes virtual link information 820-1 and virtual link information 820-2 on the virtual link 250-1 and the virtual link 250-2, respectively, which connect the virtual node C (200-3) allocated to the physical node C (100-3).

This invention is not limited to the data format of the virtual node management information 323; the data format may be a different one, such as a table format.

FIG. 6 is an explanatory diagram illustrating a configuration example of a physical node 100 in Embodiment 1 of this invention. Although FIG. 6 illustrates the physical node C (100-3) by way of example, the physical node A (100-1), the physical node B (100-2), and the physical node D (100-4) have the same configuration.

The physical node C (100-3) includes a plurality of servers 900, an in-node switch 1000, and a GRE converter 1100. Inside the physical node C (100-3), a VLAN is created.

Each server 900 includes a CPU 910, a primary storage device 920, an NIC 930, and a secondary storage device 940.

The CPU 910 executes programs stored in the primary storage device 920. The CPU 910 executes the programs to perform the functions of the server 900. The primary storage device 920 stores programs to be executed by the CPU 910 and information required to execute the programs.

The NIC 930 is an interface for connecting the physical node to other apparatuses via network lines. The secondary storage device 940 stores a variety of information.

In this embodiment, a physical node 100 includes a server 900 including a node management unit 931 and a server 900 including a virtualization management unit 932. The CPU 910 executes a specific program stored in the primary storage device 920 to implement the node management unit 931 or the virtualization management unit 932.

When the following description is provided by a sentence with a subject of the node management unit 931 or the virtualization management unit 932, the sentence indicates that the program for implementing the node management unit 931 or the virtualization management unit 932 is being executed by the CPU 910.

The node management unit 931 is the same as the node management unit 190. The node management unit 931 holds virtual node management information 320 to manage the virtual nodes 200 allocated to the physical node 100.

The virtualization management unit 932 creates VMs 110 using computer resources and manages the created VMs 110. An example of the virtualization management unit 932 is a hypervisor. The methods of creating and managing VMs 110 are known; accordingly, detailed explanation thereof is omitted.

The server 900 running the node management unit 931 is connected to the in-node switch 1000 and the GRE converter 1100 via a management network and is also connected to the domain management server 300 via the physical link 500-3. The servers 900 running the virtualization management units 932 are connected to the in-node switch 1000 via an internal data network.

The in-node switch 1000 connects the servers 900 and the GRE converter 1100 in the physical node C (100-3). The in-node switch 1000 has a function for managing a VLAN and transfers packets within the VLAN. Since the configuration of the in-node switch 1000 is known, the explanation thereof is omitted; however, the in-node switch 1000 includes, for example, a switching transfer unit (not shown) and an I/O interface (not shown) having one or more ports.

The GRE converter 1100 corresponds to the link management unit 160; it manages connections among physical nodes 100. The GRE converter 1100 creates GRE tunnels 600 and communicates with other physical nodes 100 via the GRE tunnels 600. The GRE converter 1100 includes computer resources such as a CPU (not shown), a memory (not shown), and a network interface.

This embodiment employs the GRE converter 1100 because virtual links 250 are provided using GRE tunnels 600; however, this invention is not limited to this. A router and an access gateway apparatus based on a protocol for implementing virtual links 250 may be alternatively used.

The GRE converter 1100 holds path configuration information 1110. The path configuration information 1110 is information representing connections of GRE tunnels 600 to communicate with virtual nodes 200. The GRE converter 1100 can switch connections to virtual nodes 200 using the path configuration information 1110. The details of the path configuration information 1110 will be described later with reference to FIG. 8.

When sending a packet to a VM 110 running on a remote physical node 100, the GRE converter 1100 attaches a GRE header to the packet in the local physical node 100 to encapsulate it and sends the encapsulated packet. When receiving a packet from a VM 110 running on a remote physical node 100, the GRE converter 1100 removes a GRE header from the packet and converts (decapsulates) it into a Mac-in-Mac packet for the VLAN to transfer the converted packet to a VM 110 in the physical node 100.

Now, the format of packets transmitted between physical nodes 100 is described.

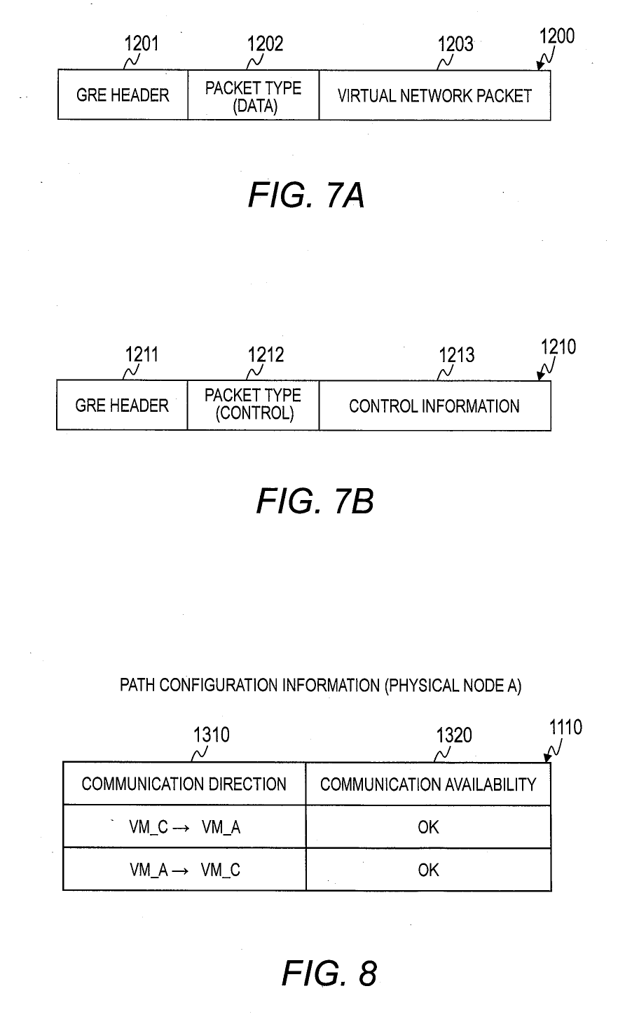

FIGS. 7A and 7B are explanatory diagrams illustrating examples of packet format in Embodiment 1 of this invention. FIG. 7A illustrates the packet format of a data packet 1200 and FIG. 7B illustrates the packet format of a Control packet 1210.

A data packet 1200 consists of a GRE header 1201, a packet type 1202, and a virtual network packet 1203.

The GRE header 1201 stores a GRE header. The packet type 1202 stores information indicating the type of the packet. In the case of a data packet 1200, the packet type 1202 stores “DATA”. The virtual network packet 1203 stores a packet to be transmitted in the virtual network or the slice 20.

A control packet 1210 consists of a GRE header 1211, a packet type 1212, and control information 1213.

The GRE header 1211 and the packet type 1212 are the same as the GRE header 1201 and the packet type 1202, respectively, although the packet type 1212 stores “CONTROL”. The control information 1213 stores a command and information required for control processing.

Data packets 1200 are transmitted between VMs 110 that provide the functions of virtual nodes 200 and control packets 1210 are transmitted between servers 900 running the node management units 931 of the physical nodes 100.

When the GRE converter 1100 receives a packet from a VM 110 running on a remote physical node 100, it identifies the type of the received packet with reference to the packet type 1202 or 1212. If the received packet is a control packet 1210, the GRE converter 1100 performs control processing based on the information stored in the control information 1213. If the received packet is a data packet 1200, the GRE converter 1100 transfers a decapsulated packet to a specified server 900.

To send a data packet 1200 to a VM 110 running on a remote physical node 100, the GRE converter 1100 sends an encapsulated packet in accordance with the path configuration information 1110. To send a control packet 1210 to the domain management server 300 or a remote physical node 100, the GRE converter 1100 sends an encapsulated packet via a GRE tunnel 600.

FIG. 8 is an explanatory diagram illustrating an example of the path configuration information 1110 in Embodiment 1 of this invention. FIG. 8 explains the path configuration information 1110 included in the GRE converter 1100 in the physical node A (100-1) by way of example.

The path configuration information 1110 includes communication directions 1310 and communication availabilities 1320.

A communication direction 1310 stores information indicating the communication direction between VMs 110, namely, information indicating the communication direction of a GRE tunnel 600.

Specifically, the communication direction 1310 stores identification information on the VM 110 of the transmission source and the VM 110 of the transmission destination. Although the example of FIG. 8 uses an arrow to represent the communication direction, this invention is not limited to this; any data format is acceptable if the VMs 110 of the transmission source and the transmission destination can be identified.

A communication availability 1320 stores information indicating whether to connect the communication between the VMs 110 represented by the communication direction 1310. In this embodiment, if communication between the VMs 110 is to be connected, the communication availability 1320 stores “OK” and if communication between the VMs 110 is not to be connected, the communication availability 1320 stores “NO”.

### (Migration)

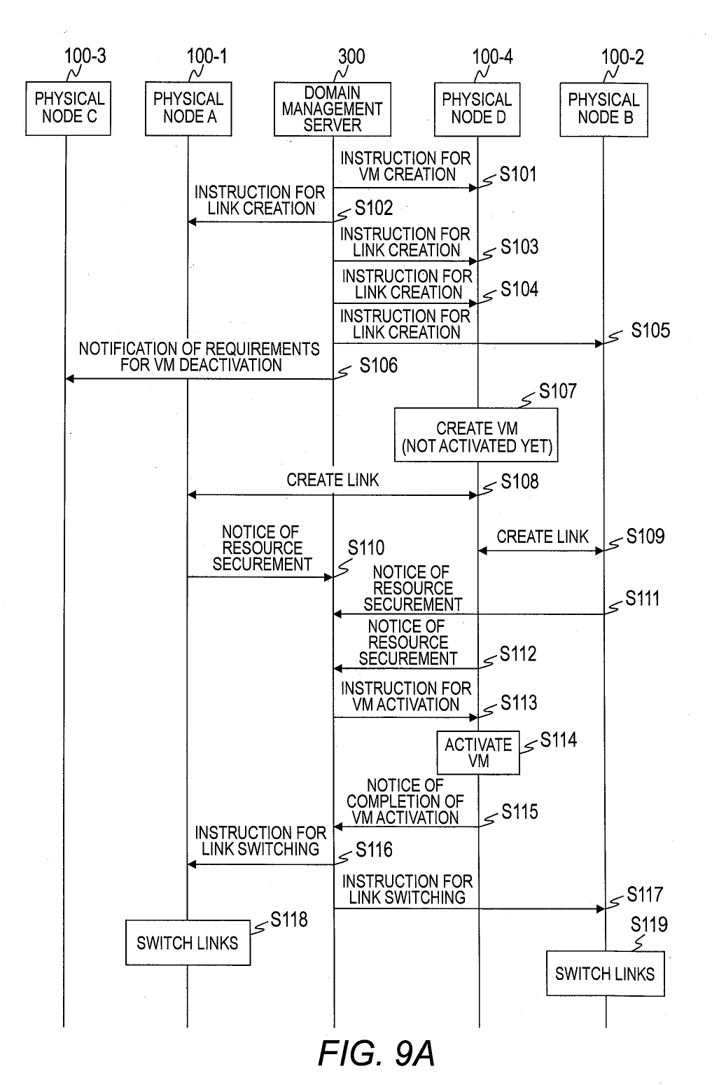

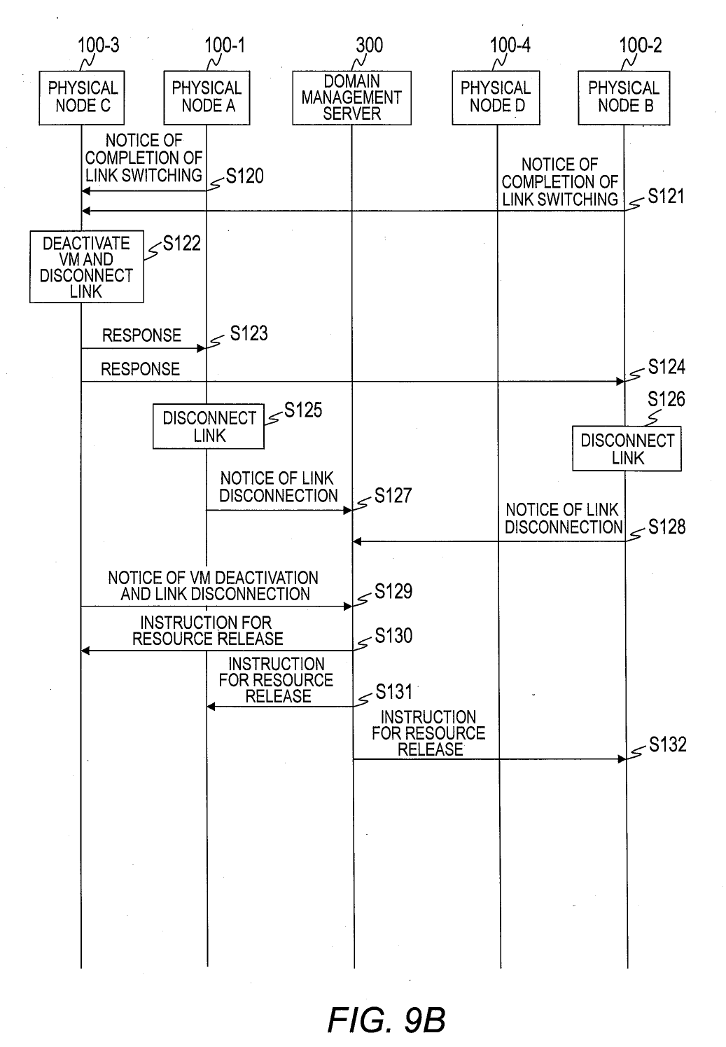

Hereinafter, migration of the virtual node C (200-3) from the physical node C (100-3) to the physical node D (100-4) will be described with reference to FIGS. 9A, 9B, 10A, 10B, 10C, 11A, 11B, 12A, and 12B.

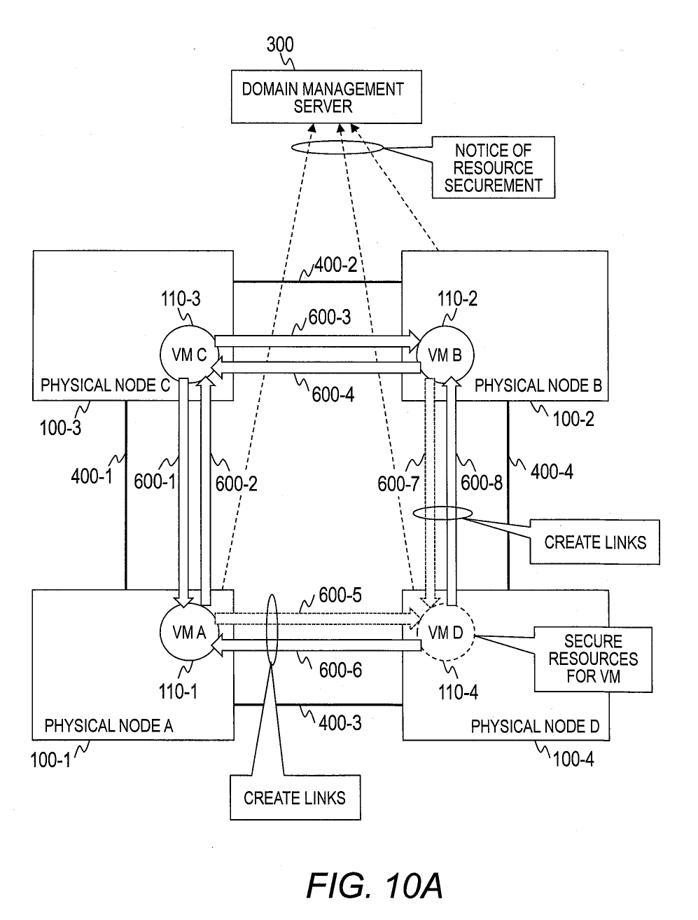

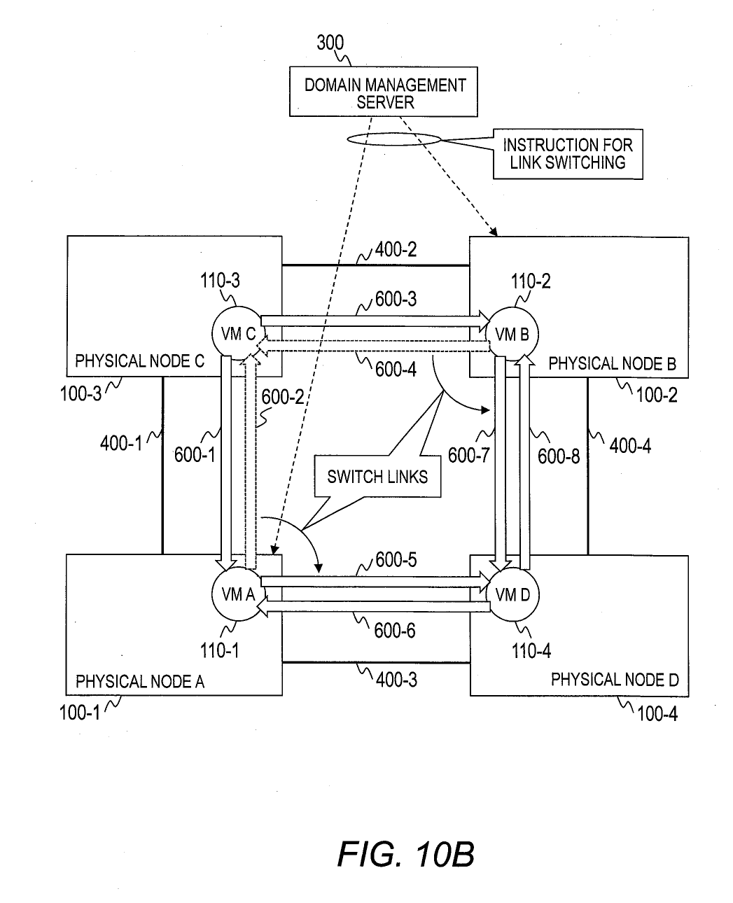

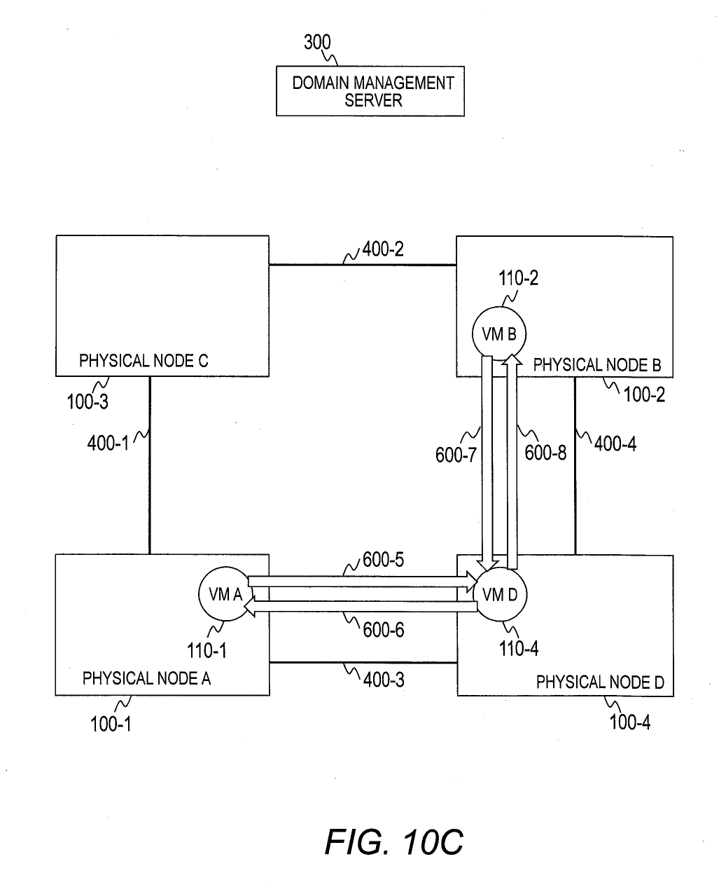

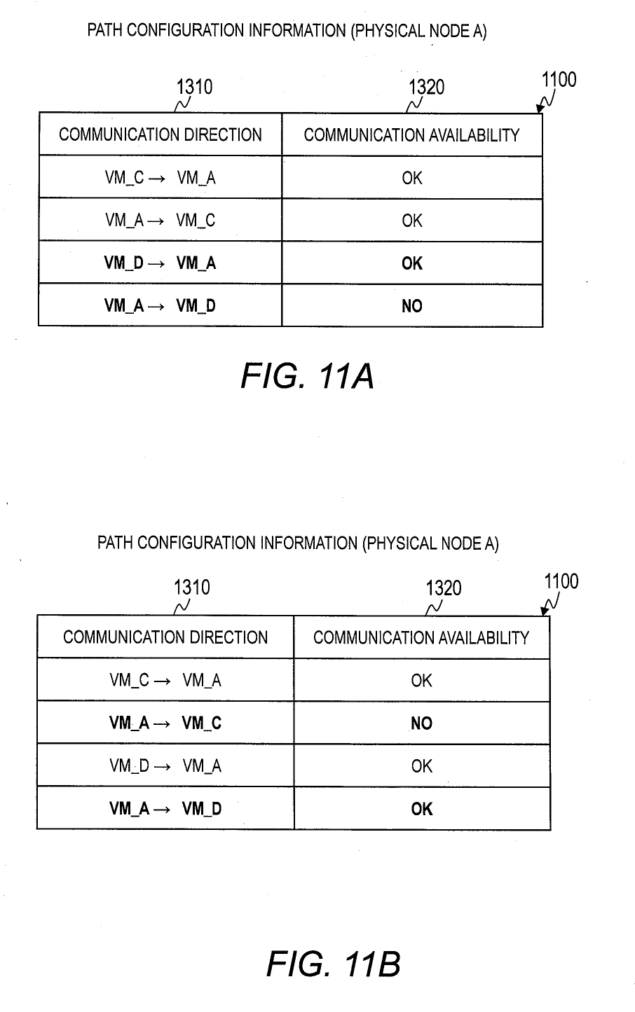

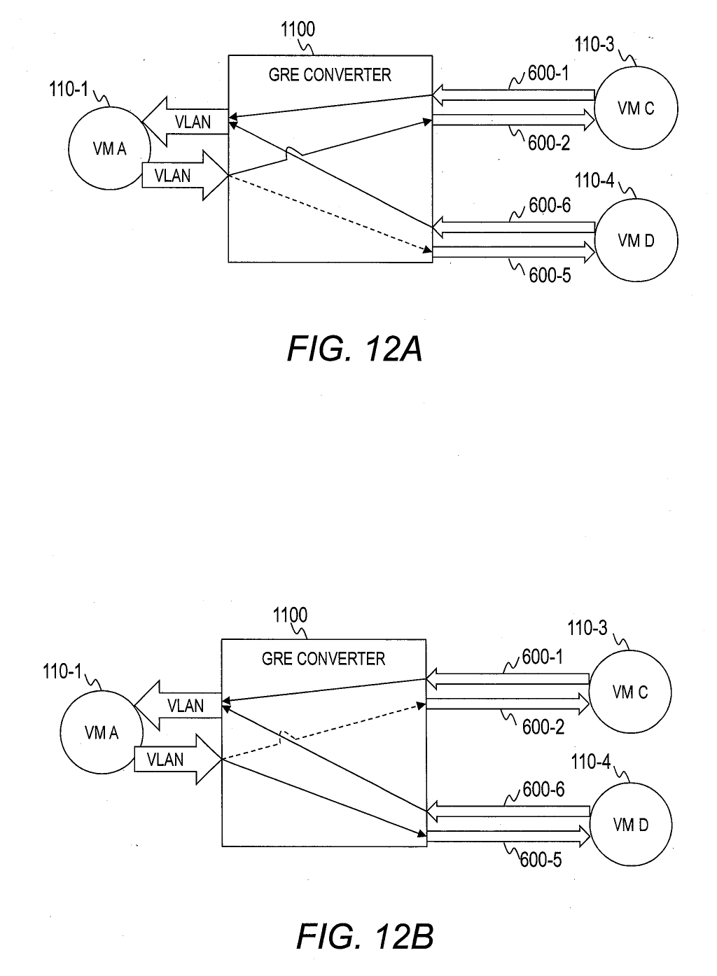

FIGS. 9A and 9B are sequence diagrams illustrating a processing flow of migration in Embodiment 1 of this invention. FIGS. 10A, 10B, and 10C are explanatory diagrams illustrating states in the domain 15 during the migration in Embodiment 1 of this invention. FIGS. 11A and 11B are explanatory diagrams illustrating examples of the path configuration information 1110 in Embodiment 1 of this invention. FIGS. 12A and 12B are explanatory diagrams illustrating connection states of communication paths in the GRE converter 1100 in Embodiment 1 of this invention.

This embodiment is based on the assumption that the administrator who operates the domain management server 300 enters a request for start of migration together with the identifier of the virtual node C (200-3) to be the subject of migration. This invention is not limited to the time to start the migration. For example, the migration may be started when the load to a VM 110 exceeds a threshold.

The domain management server 300 first secures computer resources required for the migration and configures information used in the migration. Specifically, Steps S101 to S106 are performed.

These are preparation for preventing interruption of the service executed in the slice 20 and switching VMs 110 in no time.

The domain management server 300 sends an instruction for VM creation to the physical node D (100-4) (Step S101).

Specifically, the domain management server 300 sends an instruction to create a VM_D (110-4) to the node management unit 931 of the physical node D (100-4). The instruction for VM creation includes a set of configuration information for the VM_D (110-4). The configuration information for a VM 110 includes, for example, the CPU to be allocated, the size of memory to be allocated, the path name of the OS boot image, and program names to provide the service to be executed by the virtual node C (200-3).

The domain management server 300 creates the instruction for VM creation so that the VM-D (110-4) will have the same capability as the VM_C (110-3). Specifically, the domain management server 300 acquires the configuration information for the VM_C (110-3) from the virtualization management unit 932 in the server 900 running the VM_C (110-3) to create the instruction for VM creation based on the acquired configuration information.

The domain management server 300 sends instructions for virtual link creation to the physical nodes A (100-1) and D (100-4) (Steps S102 and S103). In similar, the domain management server 300 sends instructions for virtual link creation to the physical nodes B (100-2) and D (100-4) (Steps S104 and S105). Specifically, the following processing is performed.

The domain management server 300 identifies the physical node C (100-3) allocated the virtual node C (200-3) with reference to the mapping information 322.

Next, the domain management server 300 identifies the virtual node A (200-1) and the virtual node B (200-2) connected via the virtual links 250-1 and 250-2 with reference to the virtual node management information 323 of the physical node C (100-3).

Furthermore, the domain management server 300 identifies the physical node A (100-1) allocated the virtual node A (200-1) and the physical node B (100-2) allocated the virtual node B (200-2) with reference to the mapping information 322.

Next, the domain management server 300 investigates the connections among virtual nodes 200 to identify neighboring virtual nodes 200 of the virtual node C (200-3). Under the connections in the slice 20 in this embodiment, the virtual nodes 200 that can be connected from the virtual node C (200-3) with one hop are defined as the neighboring virtual nodes 200. Accordingly, the virtual nodes A (200-1) and B (200-2) are the neighboring virtual nodes 200 of the virtual node C (200-3). The number of hops can be freely determined.

Furthermore, the domain management server 300 identifies the physical nodes A (100-1) and B (100-2) allocated the neighboring virtual nodes 200 as neighboring physical nodes 100.

The domain management server 300 sends instructions to create a virtual link 250-1 between the physical node A (100-1) and the physical node D (100-4). The domain management server 300 further sends instructions to create a virtual link 250-2 between the physical node B (100-2) and the physical node D (100-4).

The instruction for virtual link creation includes configuration information for the virtual link 250. The configuration information for the virtual link 250 includes, for example, a bandwidth, a GRE key required for connection, and IP addresses.

Described above is the processing at Steps S102, S103, S104, and S105.

Next, the domain management server 300 notifies the physical node C (100-3) of requirements for VM deactivation (Step S106).

The requirements for VM deactivation represent the requirements to deactivate a VM 110 running on the physical node 100 of the migration source. Upon receipt of the requirements for VM deactivation, the node management unit 931 of the physical node C (100-3) starts determining whether the requirements for VM deactivation are satisfied.

This embodiment is based on the assumption that the requirements for VM deactivation are predetermined so as to deactivate the VM_C (110-3) when notices of completion of virtual link switching are received from the neighboring physical nodes, namely, the physical nodes A (100-1) and B (100-2). In other words, the node management unit 931 of the physical node C (100-3) does not deactivate the VM_C (110-3) until receipt of notices of completion of virtual link switching from the physical node A (100-1) running the VM_A (110-1) and the physical node B (100-2) running the VM_B (110-2).

When the physical node D (100-4) receives the instruction for VM creation, it creates a VM_D (110-4) on a specific server 900 in accordance with the instruction for VM creation (Step S107). Specifically, the following processing is performed.

The node management unit 931 determines a server 900 where to create the VM_D (110-4). The node management unit 931 transfers the received instruction for VM creation to the virtualization management unit 932 running on the determined server 900.

The virtualization management unit 932 creates the VM_D (110-4) in accordance with the instruction for VM creation. After creating the VM_D (110-4), the virtualization management unit 932 responds the completion of the creation of the VM_D (110-4). At this moment, the created VM_D (110-4) is not activated.

Described above is the processing at Step S107.

When the physical nodes A (100-1) and D (100-4) receive the instructions for virtual link creation, they create GRE tunnels 600-5 and 600-6 (refer to FIG. 10A) to implement the virtual link 250-1 in accordance with the instructions for virtual link creation (Step S108). Specifically, the following processing is performed.

The node management unit 931 of the physical node A (100-1) transfers the instruction for virtual link creation received to the GRE converter 1100 upon receipt of it from the domain management server (300). Also, the node management unit 931 of the physical node D (100-4) transfers the instruction for virtual link creation received from the domain management server 300 to the GRE converter 1100 upon receipt of it.

The GRE converters 1100 of the physical nodes A (100-1) and D (100-4) create GRE tunnels 600-5 and 600-6. The GRE tunnels 600 can be created using a known technique; accordingly, the explanation thereof is omitted in this description.

The GRE converter 1100 of the physical node A (100-1) adds entries corresponding to the GRE tunnels 600-5 and 600-6 to the path configuration information 1110 as shown in FIG. 11A.

The GRE converter 1100 of the physical node A (100-1) sets “NO” to the communication availability 1320 of the entry for the GRE tunnel 600-5 and “OK” to the communication availability 1320 of the entry for the GRE tunnel 600-6 (refer to FIG. 11A).

In the meanwhile, the GRE converter 1100 of the physical node D (100-4) adds entries corresponding to the GRE tunnels 600-5 and 600-6 to the path configuration information 1110 and sets “OK” to the communication availabilities 1320 of the entries.

Through the above-described processing, a virtual link 250 that allows only unidirectional communication from the VM_D (110-4) to the VM_A (110-1) is created between the physical nodes A (100-1) and D (100-4).

Described above is the processing at Step S108.

In similar, the physical nodes B (100-2) and D (100-4) create GRE tunnels 600-7 and 600-8 (refer to FIG. 10A) to implement the virtual link 250-2 in accordance with the instructions for virtual link creation upon receipt of them (Step S109).

On this occasion, the GRE converter 1100 of the physical node B (100-2) sets “NO” to the communication availability 1320 of the entry for the GRE tunnel 600-7 and “OK” to the communication availability 1320 of the entry for the GRE tunnel 600-8. The GRE converter 1100 of the physical node D (100-4) sets “OK” to the communication availabilities 1320 of the entries for the GRE tunnels 600-7 and 600-8.

After creating the virtual links 250, the node management units 931 of the physical nodes A (100-1) and B (100-2) send the domain management server 300 notices indicating that the computer resources have been secured (Steps S110 and S111).

In the meanwhile, the node management unit 931 of the physical node D (100-4) sends the domain management server 300 a notice indicating that the computer resources have been secured after creating the VM_D (110-4) and the virtual links 250 (Step S112).

In response, the domain management server 300 creates update information for the mapping information 322 and the virtual node management information 323 based on the notices indicating the computer resources have been secured and stores it on a temporal basis. In this embodiment, the domain management server 300 creates the information as follows.

The domain management server 300 creates update information for the mapping information 322 in which the entry corresponding to the virtual node C (200-3) includes the physical node D (100-4) in the physical node ID 720 and the VM_D (110-4) in the VM ID 730. The domain management server 300 also creates virtual node management information 323 on the physical node D (100-4). The domain management server 300 may acquire the virtual node management information 323 from the physical node D (100-4).

FIG. 10A illustrates the state of the domain 15 when the processing up to Step S112 is done.

In FIG. 10A, the GRE tunnels 600-5 and 600-7 are represented by dotted lines, which mean that the GRE tunnels 600-5 and 600-7 are present but they cannot be used to transmit packets. Now using FIG. 12A, a connection state of communication paths in the GRE converter 1100 of the physical node A (100-1) is explained.

As shown in FIG. 12A, the GRE converter 1100 configures its internal communication paths so as to transfer the packets received from both of the VM_C (110-3) and the VM_D (110-4) to the VM_A (110-1). The GRE converter 1100 also configures its internal communication paths so as to transfer the packets received from the VM_A (110-1) only to the VM_C (110-3). As previously described, the GRE converter 1100 controls the packets not to be transferred to the GRE tunnel 600-5.

The explanation returns to FIG. 9A.

The domain management server 300 sends an instruction to activate the VM_D (110-4) to the physical node D (100-4) (Step S113). Specifically, the instruction to activate the VM_D (110-4) is sent to the node management unit 931 of the physical node D (100-4).

The role of this instruction is to prevent the VM_D (110-4) from operating before creation of virtual links 250.

The node management unit 931 of the physical node D (100-4) instructs the virtualization management unit 932 to activate the VM_D (110-4) (Step S114) and sends a notice of completion of activation of the VM_D (110-4) to the domain management server 300 (Step S115).

At the time when the service of the virtual node C (200-3) is started by the activation of the VM_D (110-4), both of the VM_C (110-3) and the VM_D (110-4) can provide the function of the virtual node C (200-3). At this time, however, the virtual node C (200-3) that uses the function provided by the VM_C (110-3) may be still working on the service in progress. Accordingly, the virtual node C (200-3) using the function provided by the VM_C (110-3) successively executes the service.

However, as shown in FIG. 10A, the virtual node C (200-3) using the function provided by the VM_D (110-4) also has started service. For this reason, even if the virtual links 250 are switched, the service is not interrupted. When seeing from the user using the slice 20, it can be recognized as if the service is executed by a single virtual node C (200-3)

It should be noted that, in this embodiment, the service executed by the virtual node C (200-3) is stateless. That is to say, if the VM 110 providing the function to the virtual node C (200-3) executing the service is switched to another, the VMs 110 can perform processing independently. If the service executed by the virtual node C (200-3) is not stateless, providing a shared storage to share state information between the migration source VM 110 and the migration destination VM 110 enables continued service.

After the domain management server 300 receives the notice of completion of activation of the VM_D (110-4), it sends instructions for virtual link switching to the neighboring physical nodes, namely the physical node A (100-1) and the physical node B (100-2) (Steps S116 and S117). Each instruction for virtual link switching includes identification information on the GRE tunnels 600 to be switched.

Upon receipt of the instructions for virtual link switching, the physical node A (100-1) and the physical node B (100-2) switch the virtual links 250 (Steps S118 and S119). Specifically, the following processing is performed.

Upon receipt of an instruction for virtual link switching, the node management unit 931 transfers the received instruction to the GRE converter 1100.

The GRE converter 1100 refers to the path configuration information 1110 to identify the entries for the GRE tunnels 600 to be switched based on the identification information on the GRE tunnels 600 included in the received instruction for virtual link switching. On this occasion, the entries for the GRE tunnel 600 connected to the VM_C (110-3) of the migration source and the GRE tunnel 600 connected to the VM_D (110-4) of the migration destination are identified.

The GRE converter 1100 replaces the values set to the communication availabilities 1320 between the identified entries. Specifically, it changes the communication availability 1320 of the entry for the GRE tunnel 600 connected to the VM 110 of the migration source into “NO” and the communication availability 1320 of the entry for the GRE tunnel 600 connected to the VM 110 of the migration destination into “OK”.

Through this operation, the path configuration information 1110 is updated into the one as shown in FIG. 11B.

The GRE converter 1100 switches the internal communication paths connected to the GRE tunnels 600 in accordance with the updated path configuration information 1110. The GRE converter 1100 sends a notice of completion of switching the communication paths to the node management unit 931.

Even after switching the internal communication paths, if a packet received by the GRE converter 1100 is a control packet 1210 and the destination of the control packet is the physical node 100 that had been allocated the virtual node 200 before the migration, the GRE converter 1100 can send the control packet 1210 via the internal communication path that had been used before the switching of the virtual links 250.

In other words, the GRE converter 1100 controls data packets 1200 so as not to be transferred to the physical node 100 that had been allocated the virtual node 200 before the migration.

Through the processing described above, the internal communication paths are switched as shown in FIG. 12B. At this moment, the migration of the virtual node C (200-3) to the VM_D (110-4) is completed. The virtual links 250 in the overall system are switched as shown in FIG. 10B.

In this way, the virtual links 250 are switched after a certain time period has passed in order to obtain the result of the service executed by the virtual node C (200-3) using the function provided by the VM_C (110-3). This approach assures the consistency in the service of the slice 20.

Described above is the processing at Steps S118 and S119.

After switching the virtual links 250, the virtual node C (200-3) that uses the function provided by the VM_D (110-4) executes the service. At this time, however, the node management unit 931 of the physical node C (100-3) maintains the VM_C (110-3) active since the requirements for deactivation of the VM_C (110-3) are not satisfied.

After switching the connection of the GRE tunnels 600 for implementing the virtual links 250, the physical nodes A (100-1) and B (100-2) send notices of completion of virtual link switching to the physical node C (100-3) (Steps S120 and S121). Specifically, the following processing is performed.

The node management unit 931 of each physical node 100 inquires the GRE converter 1100 of the result of switching the virtual link 250 to identify the GRE tunnel 600 to which the connection is switched. The GRE converter 1100 outputs information on the entry newly added to the path configuration information 1110 to identify the GRE tunnel to which the connection is switched.

The node management unit 931 of each physical node 100 identifies the physical node 100 which runs the VM 110 to which the identified GRE tunnel 600 is connected with reference to the identifier of the VM 110. For example, the node management unit 931 of each physical node 100 may send an inquiry including the identifier of the identified VM to the domain management server 300. In this case, the domain management server 300 can identify the physical node 100 that runs the identified VM 110 with reference to the mapping information 322.

The method of identifying the physical node 100 to send a notice of completion of virtual link switching is not limited to the above-described one. For example, the node management unit 931 may originally hold information associating GRE tunnels 600 with connected physical nodes 100.

The node management unit 931 creates a notice of completion of virtual link switching including the identifier of the connected physical node 100 and sends it to the GRE converter 1100. It should be noted that the notice of completion of virtual link switching is a control packet 1210.

The GRE converter 1100 sends the notice of completion of virtual link switching to the connected physical node 100 via the GRE tunnel 600.

Described above is the processing at Steps S120 and S121.

Next, the physical node C (100-3) deactivates, upon receipt of the notices of completion of virtual link switching from the physical nodes A (100-1) and B (100-2), the VM_C (110-3) and the connection of the GRE tunnels 600 (Step S122).

This is because that the node management unit 931 of the physical node C (100-3) has determined that the requirements for deactivation of the VM_C (110-3) are satisfied.

As mentioned above, the notices of completion of virtual link switching are transmitted via the GRE tunnels 600-2 and 600-4 for transmitting data packets 1200. Accordingly, the node management unit 931 of a physical node 100 is assured that data packets 1200 are no longer sent from the VM_A (110-1) or VM_B (110-2) to the VM_C (110-3) by receiving the notices of completion of virtual link switching.

If the domain management server 300 is configured to send the notice of completion of virtual link switching, the control packet 1210 corresponding to the notice of completion of virtual link switching is transmitted via a communication path different from the communication path for transmitting data packets 1200. Accordingly, there remains a possibility that data packets 1200 may be transmitted via the GRE tunnels 600-2 or 600-4.

On the other hand, the above configuration is capable of recognizing that the VM 110 which had provided the function to the virtual node 200 before migration is no longer necessary by receiving control packets 1210 from all the physical nodes 100 communicating with the VM 110 running on the physical node 100 before migration.

The physical node C (100-3) sends responses to the notices of completion of virtual link switching to the physical nodes A (100-1) and B (100-2) (Steps S123 and S124).

Since these responses are control packets 1210, they are transmitted via the GRE tunnels 600-1 and 600-3. Accordingly, the physical nodes 100 can be assured that packets are no longer sent from the VM 110 that had implemented functions before migration.

Upon receipt of the response to the notice of completion of virtual link switching, each of the physical node A (100-1) and B (100-2) disconnects the GRE tunnel 600 for communicating with the VM_C (100-3) (Steps S125 and S126).

Specifically, the node management unit 931 of each physical node 100 sends the GRE converter 1100 an instruction to disconnect the GRE tunnel 600 for communicating with the VM_C (110-3). Upon receipt of the instruction for disconnection, the GRE converter 1100 stops communication via the GRE tunnel 600 for communicating with the VM_C (110-3).

The physical nodes A (100-1) and B (100-2) each send a notice of virtual link disconnection to the domain management server 300 (Steps S127 and S128). The physical node C (100-3) notifies the domain management server 300 of deactivation of the VM_C (110-3) and disconnection to the VM_C (110-3) (Step S129).

The domain management server 300 sends instructions to release the computer resources related to the VM_C (110-3) to the physical nodes A (100-1), B (100-2), and C (100-3) (Steps S130, S131, and S132).

Specifically, the domain management server 300 instructs the physical node A (100-1) to release the computer resources allocated to the GRE tunnels 600-1 and 600-2 and the physical node B (100-2) to release the computer resources allocated to the GRE tunnels 600-3 and 600-4. The domain management server 300 also instructs the physical node C (100-3) to release the computer resources allocated to the VM_C (110-3) and the GRE tunnels 600-1, 600-2, 600-3, and 600-4. As a result, effective use of computer resources is attained.

In FIGS. 9A and 9B, the instructions and responses exchanged between the domain management server 300 and each physical node 100 may be issued in any sequence within the range of consistency of processing or may be issued simultaneously. The same instruction or response may be sent a plurality of times. Alternatively, a single instruction or response may be separated into a plurality of instructions or responses to be sent.

FIG. 10C is a diagram illustrating the state of the domain after the processing up to Step S132 is done. FIG. 10C indicates that the virtual node C (200-3) has been transferred from the physical node C (100-3) to the physical node D (100-4). It should be noted that the transfer of the virtual node C (200-3) is not recognized in the slice 20.

Embodiment 1 enables migration of a virtual node 200 in a slice 20 between physical nodes 100 without interrupting the service being executed by the virtual node 200 or changing the network configuration of the slice 20.

### Embodiment 2

Embodiment 2 differs from Embodiment 1 in the point that the created virtual network 20 ranges in two or more domains 15. Hereinafter, migration of a virtual node 200 between domains 15 is described. Differences from Embodiment 1 are mainly described.

### (System Configuration)

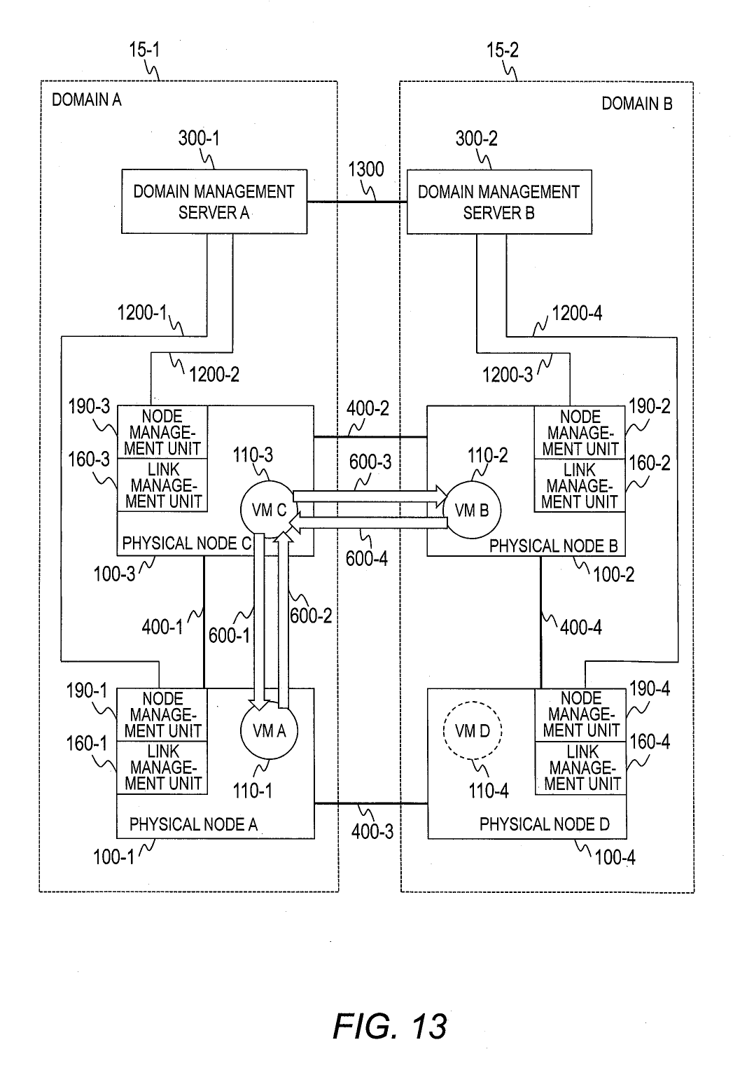

FIG. 13 is an explanatory diagram illustrating a configuration example of the physical network 10 in Embodiment 2 of this invention. Embodiment 2 is described using a physical network 10 under two domains 15 by way of example.

The domain A (15-1) and the domain B (15-2) forming the physical network 10 each includes a domain management server 300 and a plurality of physical nodes 100. Embodiment 2 is based on the assumption that the slice 20 shown in FIG. 2 is provided using physical nodes 100 in the both domains 15. The slice 20 ranging in two domains 15 can be created using federation function.

The domain management server A (300-1) and the domain management server B (300-2) are connected via a physical link 1300. The domain management server A (300-1) and the domain management server B (300-2) communicate with each other via the physical link 1300 to share the management information (such as the mapping information 322 and the virtual node management information 323) of the domains 15.

The configuration of each domain management server 300 is the same as that of Embodiment 1; accordingly, the explanation thereof is omitted. In addition, connections among physical nodes 100 are the same as those of Embodiment 1; the explanation thereof is omitted.

In Embodiment 2, the physical link 400-2 connecting the physical node B (100-2) and the physical node C (100-3) and the physical link 400-3 connecting the physical node A (100-1) and the physical node D (100-4) are the network connecting the domains 15.

For this reason, gateway apparatuses may be installed at the gates of the domains 15 depending on the implementation of the physical network 10. This embodiment is based on the configuration that direct connection of physical nodes 100 between the two domains 15 is available with GRE tunnels 600; but in the case where gateways are installed, the same processing can be applied.

The configuration of each physical node 100 is the same as that of Embodiment 1; the explanation thereof is omitted.

### (Migration)

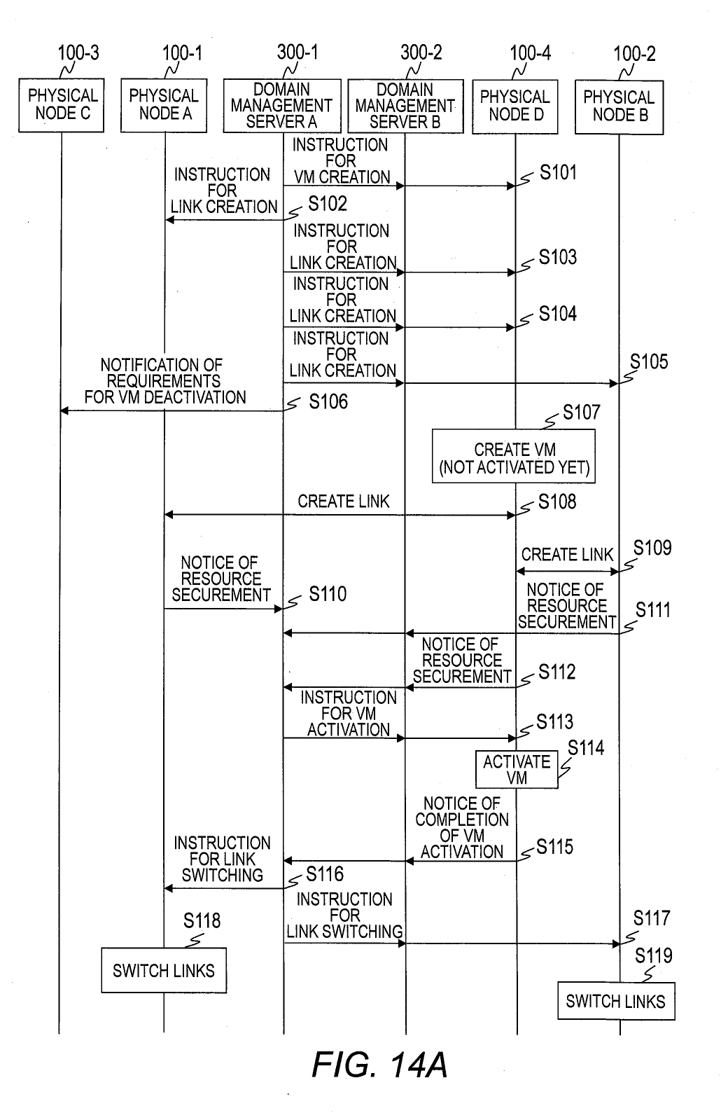

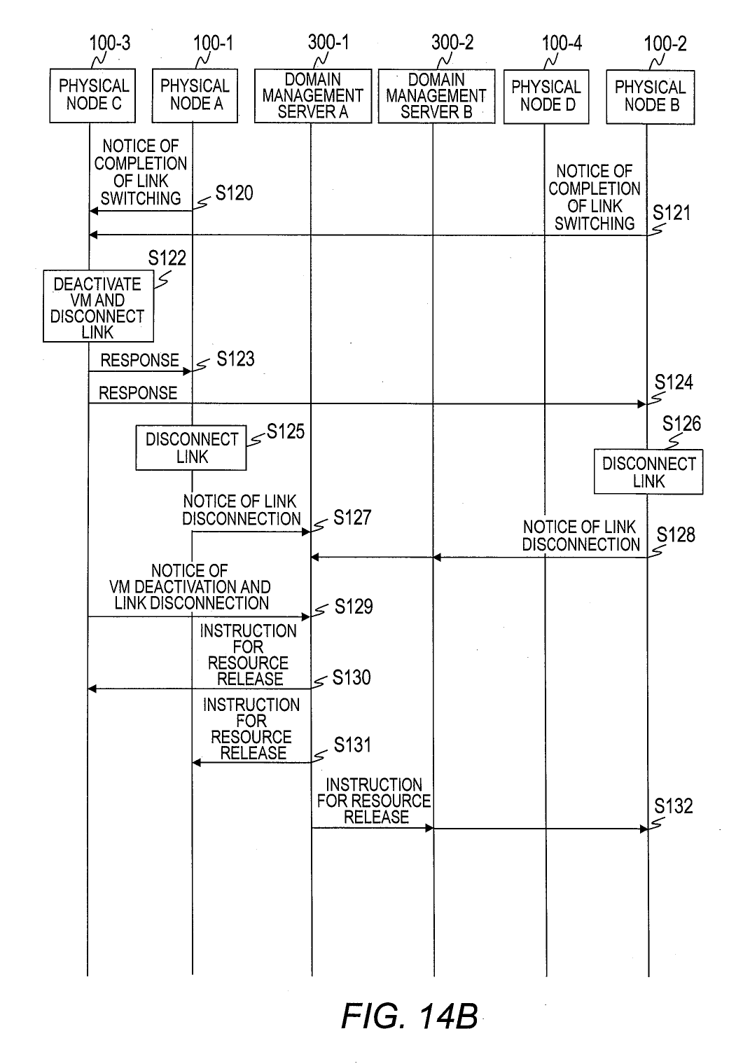

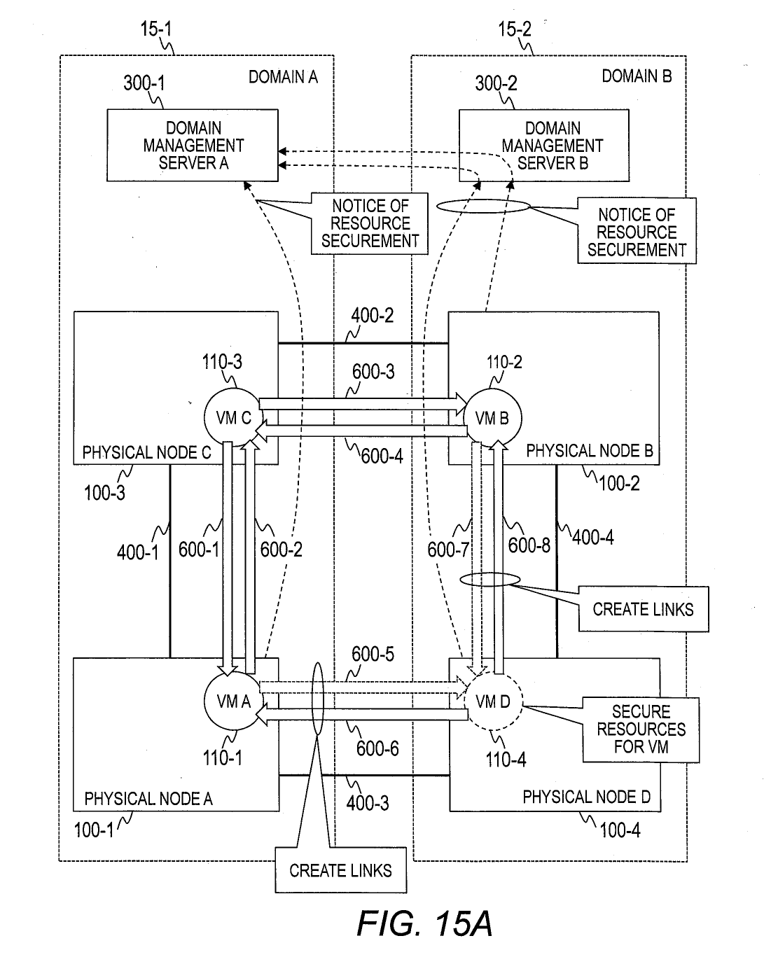

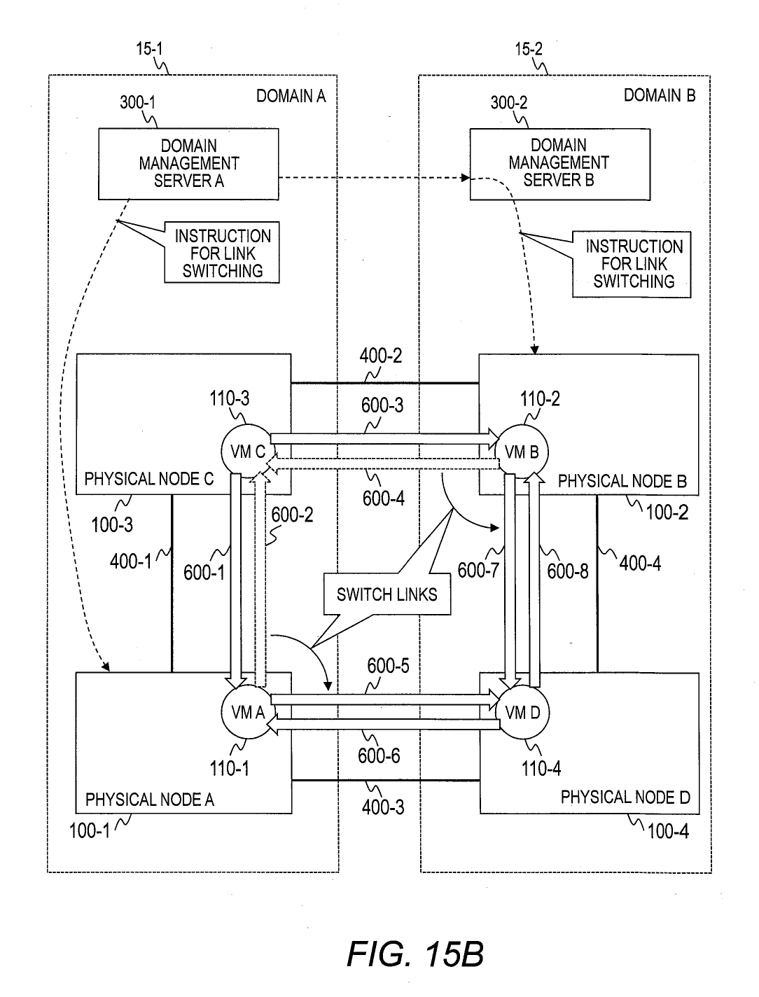

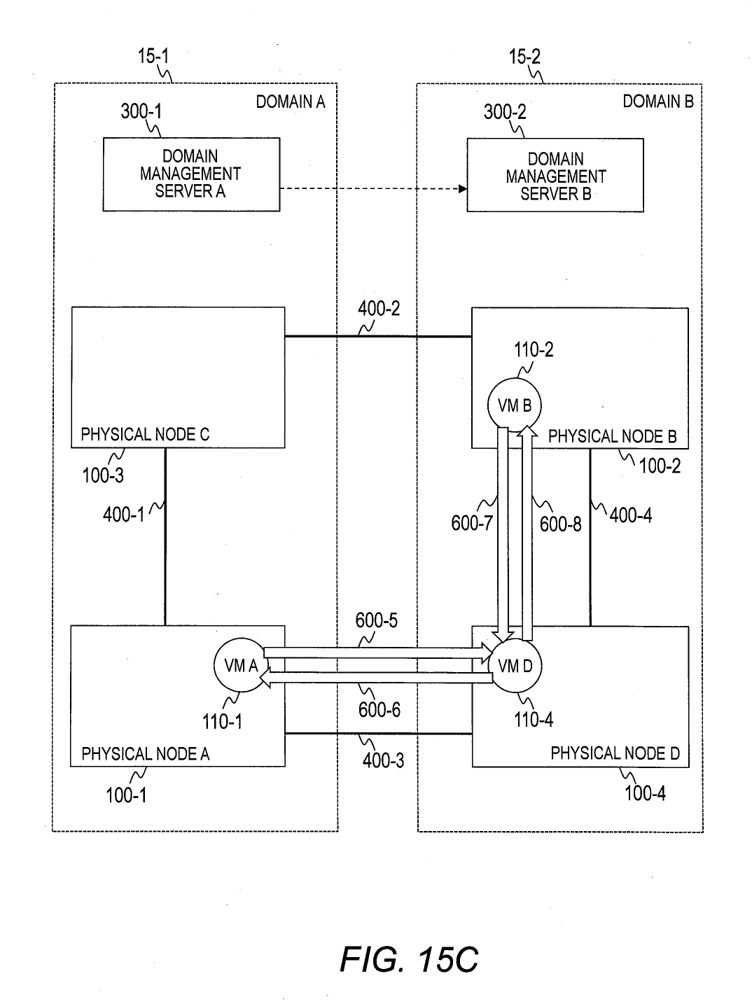

Hereinafter, like in Embodiment 1, migration of the virtual node C (200-3) from the physical node C (100-3) to the physical node D (100-4) will be described with reference to FIGS. 14A, 14B, 15A, 15B, and 15C. However, it is different in the point that the virtual node 200 is transferred between physical nodes 100 in different domains 15.

FIGS. 14A and 14B are sequence diagrams illustrating a processing flow of migration in Embodiment 2 of this invention. FIGS. 15A, 15B, and 15C are explanatory diagrams illustrating states in the domains 15 during the migration in Embodiment 2 of this invention.

The method of updating the path configuration information 1110 and the method of controlling the internal communication paths in the GRE converter 1100 are the same as those in Embodiment 1; the explanation of these methods is omitted.

This embodiment is based on the assumption that the administrator who operates the domain management server A (300-1) enters a request for start of migration together with the identifier of the virtual node C (200-3) to be the subject of migration. This invention is not limited to the time to start the migration. For example, the migration may be started when the load to a VM 110 exceeds a threshold.

In this embodiment, the domain management servers A (300-1) and B (300-2) cooperate to execute the migration, but the domain management server A (300-1) takes charge of migration. The same processing can be applied to the case where the domain management server B (300-2) takes charge of migration.

The domain management server 300 creates an instruction for VM creation so that the VM-D (110-4) to be created will have the same capability as the VM_C (110-3). Specifically, the domain management server 300 acquires the configuration information for the VM_C (110-3) from the virtualization management unit 932 in the server 900 running the VM_C (110-3) to create the instruction for VM creation based on the acquired configuration information.

In Embodiment 2, the sending of the instruction for VM creation to the physical node D (100-4) is different (Step S101).

Specifically, the domain management server A (300-1) sends the instruction for VM creation to the domain management server B (300-2). The instruction for VM creation includes the identifier of the destination physical node D (100-4) for the address information.

The domain management server B (300-2) transfers the instruction to the physical node D (100-4) in accordance with the address information in the received instruction.

This embodiment is based on the assumption that the instruction for VM creation originally includes the identifier of the destination physical node D (100-4); however, this invention is not limited to this. For example, the domain management server A (300-1) may send an instruction for VM creation same as the one in Embodiment 1 and the domain management server B (300-2) may determine the physical node 100 to forward the instruction in consideration of information on the loads of the physical nodes 100 in the domain B (15-2).

In Embodiment 2, the sending of the instructions for virtual link creation to the physical nodes B (100-2) and D (100-4) is different (Steps S103, S104, and S105).

Specifically, the domain management server A (300-1) sends the instructions for virtual link creation to the domain management server B (300-2). Each instruction for virtual link creation includes the identifier of the destination physical node B (100-2) or D (100-4) for the address information. The domain management server A (300-1) can identify that the neighboring physical node 100 of the physical node D (100-4) is the physical node B (100-2) with reference to the mapping information 322.

The domain management server B (300-2) transfers the received instructions for virtual link creation to the physical nodes B (100-2) and D (100-2) in accordance with the address information of the instructions.

Upon receipt of the instructions for virtual link creation, the physical nodes A (100-1) and D (100-4) creates GRE tunnels 600-5 and 600-6 (refer to FIG. 15A) for implementing the virtual link 250-1 based on the instructions for virtual link creation (Step S108).

The method of creating the GRE tunnels 600-5 and 600-6 is basically the same as the creation method described in Embodiment 1. Since the slice is created to range in a plurality of domains by federation in this embodiment, the GRE tunnels are also created between domains. It should be noted that, depending on the domain, and additionally, depending on the implementation scheme of the physical network connecting the domains, the link scheme may be switched to a different one (such as VLAN) at the boundary between the domains.

After the node management unit 931 of the physical node B (100-2) creates the virtual link 250, it sends a notice indicating that the computer resources have been secured to the domain management server B (300-2) (Step S111). The domain management server B (300-2) transfers this notice to the domain management server A (300-1) (refer to FIG. 15A).

After the node management unit 931 of the physical node D (100-4) creates the VM_D (110-4) and the virtual links 250, it sends a notice indicating that the computer resources have been secured to the domain management server B (300-2) (Step S112). The domain management server B (300-2) transfers this notice to the domain management server A (300-1) (refer to FIG. 15A).

The domain management server B (300-2) may merge the notices of securement of computer resource from the physical nodes B (100-2) and D (100-4) to send the merged notice to the domain management server A (300-1).

In Embodiment 2, the instruction for VM activation and the notice of completion of VM activation are transmitted via the domain management server B (300-2) (Steps S113 and S115). The instruction for virtual link switching to the physical node B (100-2) is also transmitted via the domain management server B (300-2) (Step S117) as shown in FIG. 15B.

The notice of completion of link switching sent from the physical node B (100-2) is transmitted via the GRE tunnel 600 created on the physical link 400-2, but not via the domain management server B (300-2) (Step S121). The response to be sent to the physical node B (100-2) is also transmitted via the GRE tunnel 600 created on the physical link 400-2, but not via the domain management server B (300-2) (Step S124).

The notice of virtual link disconnection sent from the physical node B (100-2) is transmitted to the domain management server A (300-1) via the domain management server B (300-2) (Step S128). The instruction to release computer resources is also transmitted to the physical node B (100-2) via the domain management server B (300-2) (Step S132).

The other processing is the same as the Embodiment 1; accordingly, the explanation is omitted.

Embodiment 2 enables migration of a virtual node 200 between domains 15 in a slice 20 ranging in a plurality of domains 15 without interrupting the service being executed by the virtual node 200.

### Embodiment 3

Embodiment 2 generates many communications between domain management servers 300 as shown in FIGS. 14A and 14B. Since these communications include authentications between domains 15, the overhead increases. Moreover, the increase in transmission of control commands elevates the overhead in migration.

In view of the above, Embodiment 3 accomplishes migration with less communication between domain management servers 300. Specifically, the communication between domain management servers is reduced by transmitting control packets via physical links 400 between physical nodes 100.

Hereinafter, differences from Embodiment 2 are mainly described. The configurations of the physical network 10, the domain management servers 300, and the physical nodes 100 are the same as those in Embodiment 1; the explanation is omitted.

### (Migration)

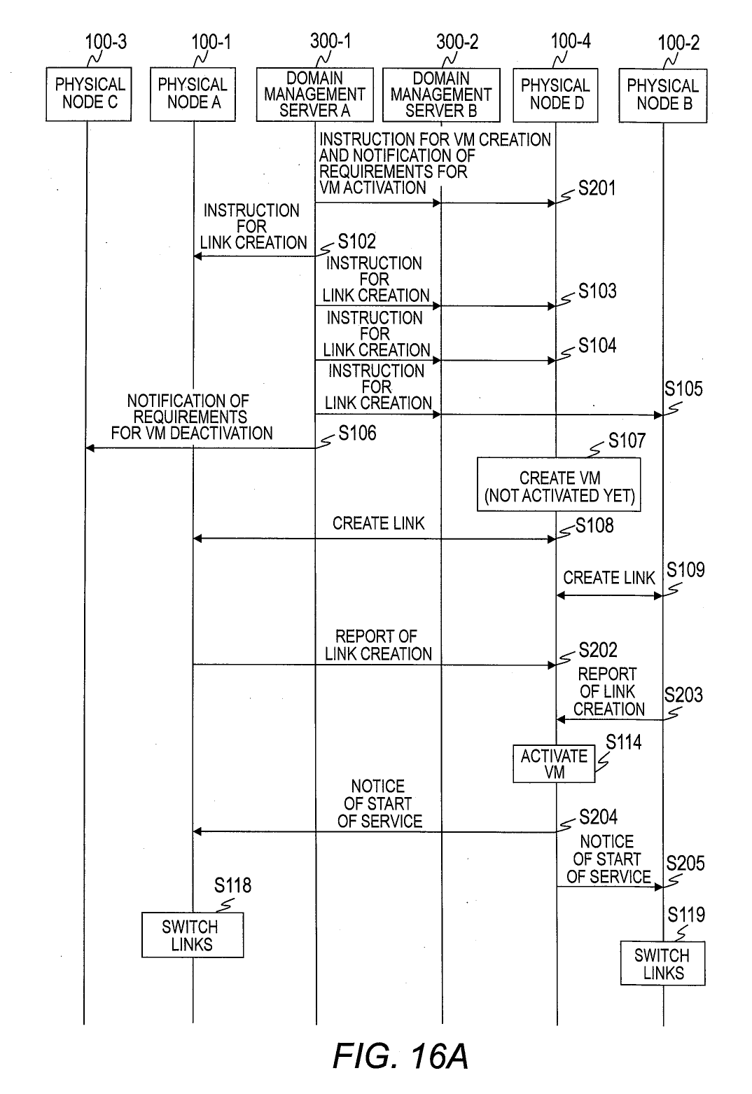

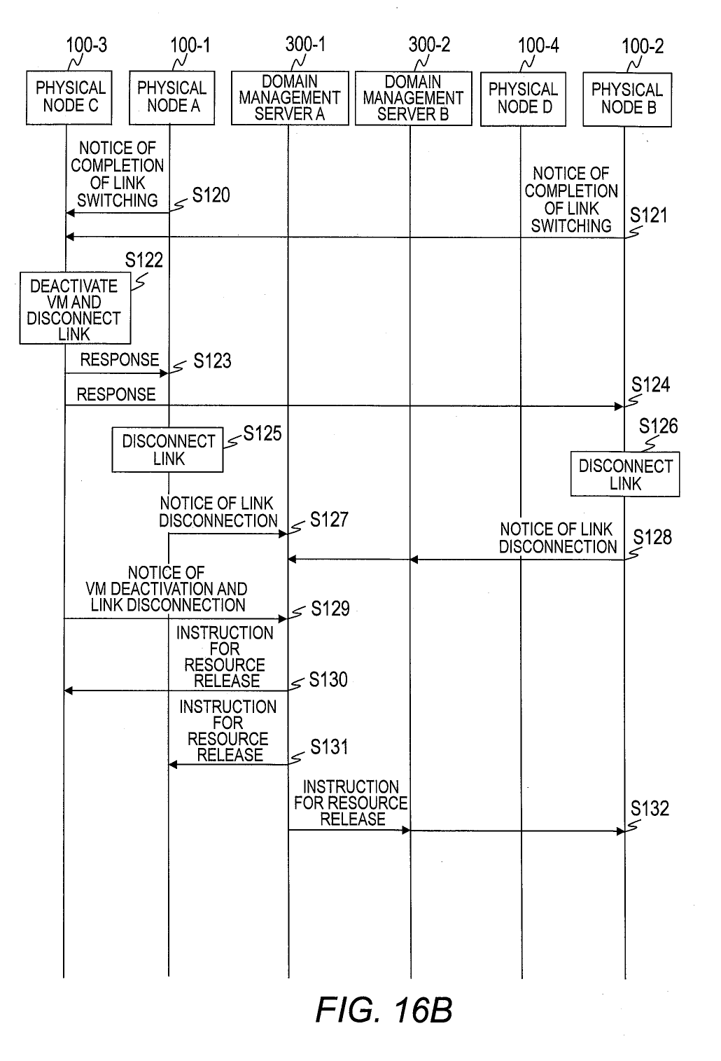

Hereinafter, like in Embodiment 2, migration of the virtual node C (200-3) from the physical node C (100-3) in the domain A (15-1) to the physical node D (100-4) in the domain B (15-2) will be described with reference to FIGS. 16A and 16B.

FIGS. 16A and 16B are sequence diagrams illustrating a processing flow of migration in Embodiment 3 of this invention.

The domain management server A (300-1) notifies the domain management server B (300-2) of an instruction for VM creation and requirements for VM activation (Step S201).

Since the virtual link 250 for the physical node D (100-4) has not been created yet at this time, the instruction for VM creation and the requirements for VM activation are transmitted to the physical node D (100-4) via the domain management server B (300-2). This is because the link to the added node has not been created yet.

The requirements for VM activation represent the requirements to activate the VM 110 created on the physical node 100 of the migration destination. Upon receipt of the requirements for VM activation, the node management unit 931 of the physical node D (100-4) starts determining whether the requirements for activation are satisfied.

This embodiment is based on the assumption that the requirements for VM activation are predetermined so as to activate the VM_D (110-4) when notices of completion of virtual link creation are received from the neighboring physical nodes, namely, the physical nodes A (100-1) and B (100-2).

In Embodiment 3, none of the node management units of the physical nodes A (100-1), B (100-2), and D (100-4) send a notice of securement of computer resources to the domain management server A (300-1). Embodiment 3 is different in the point that the node management units of the physical nodes A (100-1) and B (100-2) send reports of virtual link creation to the physical node D (100-4) via GRE tunnels 600 (Steps S202 and S203).

Through these operations, the communication between the domain management servers 300 and between the domain management servers 300 and physical nodes 100 can be reduced to activate the VM_D (110-4). Accordingly, the overhead in the migration can be reduced.

In Embodiment 3, when the node management unit 931 of the physical node D (100-4) receives reports of virtual link creation from the neighboring physical nodes 100, it instructs the virtualization management unit 932 to activate the VM_D (110-4) (Step S114).

After activating the VM_D (110-4), the node management unit 931 of the physical node D (100-4) sends notices of start of service to the neighboring physical nodes 100 (Steps S204 and S205). The notice of start of service is a notice indicating that the virtual node C (200-3) has started servicing using the function provided by the VM_D (110-4).

Specifically, the notices of start of service are transmitted to the physical nodes A (100-1) and B (100-2) via the GRE tunnels 600.

Upon receipt of the notices of start of service, the physical nodes A (100-1) and B (100-2) switch the virtual links 250 (Steps S118 and S119).

Embodiment 3 is different in the point that the physical nodes A (100-1) and B (100-2) switch the virtual links 250 in response to the notices of start of service sent from the physical node D (100-4). In other words, transmission of the notice of completion of VM activation and instructions for virtual link switching is replaced by transmission of the notice of start of service.

Although Embodiment 2 requires communication between physical nodes 100 and the domain management servers 300 to switch the virtual links 250, Embodiment 3 encourages direct communication between physical nodes, so that the communication via the domain management servers 300 can be reduced.

The other processing is the same as that in Embodiment 2; the explanation is omitted.

Embodiment 3 can reduce the communication with the domain management servers 300 by communication via the links (GRE tunnels 600) connecting physical nodes 100. Consequently, the overhead in migration can be reduced.

The variety of software used in the embodiments can be stored in various storage media, such as electro-magnetic, electronic, and optical type of non-transitory storage media, or can be downloaded to computers via communication network such as the Internet.

The embodiments have described examples using control by software but part of the control can be implemented by hardware.

As set forth above, this invention has been described in detail with reference to the accompanying drawings, but this invention is not limited to these specific configurations but includes various modifications and equivalent configurations within the scope of the appended claims.

What is claimed is:

1. A network system including physical nodes having computer resources,
the physical nodes being connected to one another via physical links,
the network system providing a virtual network system including virtual nodes allocated computer resources of the physical nodes to execute predetermined service, and
the network system comprising:
a network management unit for managing the virtual nodes;
at least one node management unit for managing the physical nodes; and
at least one link management unit for managing connections of the physical links connecting the physical nodes and connections of virtual links connecting the virtual nodes,
wherein the network management unit holds mapping information indicating correspondence relations between the virtual nodes and the physical nodes allocating the computer resources to the virtual nodes and virtual node management information for managing the virtual links,
wherein the at least one link management unit holds path configuration information for managing connection states of the virtual links, and
wherein, in a case where the network system performs migration of a first virtual node for executing service using computer resources of a first physical node to a second physical node,
the network management unit sends the second physical node an instruction to secure computer resources to be allocated to the first virtual node;
the network management unit identifies neighboring physical nodes allocating computer resources to neighboring virtual nodes connected to the first virtual node via virtual links in the virtual network;
the network management unit sends the at least one link management unit an instruction to create communication paths for implementing virtual links for connecting the first virtual node and the neighboring virtual nodes on physical links connecting the second physical node and the neighboring physical nodes;
the at least one link management unit creates the communication paths for connecting the second physical node and the neighboring physical nodes on the physical links based on the instruction to create the communication paths;
the at least one node management unit starts the service executed by the first virtual node using the computer resources secured by the second physical node;
the network management unit sends the at least one link management unit an instruction to switch the virtual links; and
the at least one link management unit switches communication paths to the created communication paths for switching the virtual links.

2. The network system according to claim 1,
wherein the at least one link management unit controls data transmission and reception between virtual nodes based on the path configuration information,
wherein, in the creating the communication paths on the physical links connecting the second physical node and the neighboring physical nodes,
the at least one link management unit creates the communication paths configured so as to permit data transmission from the first virtual node allocated the computer resources of the second physical node to the neighboring virtual nodes and prohibit data transmission from the neighboring virtual nodes to the first virtual node allocated the computer resources of the second physical node, and adds configuration information associating identification information on the created communication paths with information indicating whether to permit data transmission to the path configuration information, and
wherein, upon receipt of the instruction to switch the virtual links, the at least one link management unit updates the configuration information added to the path configuration information so as to permit data transmission from the neighboring virtual nodes to the first virtual node allocated the computer resources of the second physical node.

3. The network system according to claim 2,
wherein the network management unit sends the at least one node management unit a requirement for stopping the service executed by the first virtual node allocated the computer resources of the first physical node,
wherein the at least one node management unit determines whether the received requirement for stopping the service is satisfied, and
wherein, when it is determined that the received requirement for stopping the service is satisfied, the at least one node management unit stops the service executed by the first virtual node allocated the computer resources of the first physical node.

4. The network system according to claim 3, wherein the requirement for stopping the service is reception of notices of completion of the switching the virtual links from the neighboring physical nodes.

5. The network system according to claim 4, wherein the at least one node management unit releases the computer resources of the first physical node allocated to the first virtual node after stopping the service executed by the first virtual node allocated the computer resources of the first physical node.

6. The network system according to claim 2,
wherein each of the physical nodes includes the node management unit and the link management unit,
wherein the link management unit of the second physical node and the link management units of the neighboring physical nodes create the communication paths,
wherein the link management unit of the second physical node adds first configuration information to permit data transmission and reception via the communication paths to the path configuration information,
wherein the link management units of the neighboring nodes add second configuration information to permit data reception via the communication paths and prohibit data transmission via the communication paths to the path configuration information,
wherein the node management units of the neighboring physical nodes send the second physical node first control information indicating completion of the creating the communication paths via the created communication paths,
wherein, after receipt of the first control information, the node management unit of the second physical node allocates the secured computer resources to the first virtual node and starts the service executed by the first virtual node,
wherein the node management unit of the second physical node sends the neighboring physical nodes second control information indicating the start of the service executed by the first virtual node via the communication paths, and
wherein, after receipt of the second control information, the link management units of the neighboring physical nodes change the second configuration information so as to permit data transmission via the communication paths to switch the virtual links.

7. A method for migration of a virtual node included in a virtual network provided by a network system including physical nodes having computer resources,
the physical nodes being connected to one another via physical links,
the virtual network including virtual nodes allocated computer resources of the physical nodes to execute predetermined service,
the network system including:
a network management unit for managing the virtual nodes;
at least one node management unit for managing the physical nodes; and
at least one link management unit for managing connections of physical links connecting the physical nodes and connections of virtual links connecting the virtual nodes,
the network management unit holding mapping information indicating correspondence relations between the virtual nodes and the physical nodes allocating the computer resources to the virtual nodes and virtual node management information for managing the virtual links,
the at least one link management unit holding path configuration information for managing connection states of the virtual links,
the method, in a case of migration of a first virtual node for executing service using computer resources of a first physical node to a second physical node, comprising:
a first step of sending, by the network management unit, the second physical node an instruction to secure computer resources to be allocated to the first virtual node;
a second step of identifying, by the network management unit, neighboring physical nodes allocating computer resources to neighboring virtual nodes connected to the first virtual node via virtual links in the virtual network;
a third step of sending, by the network management unit, the at least one link management unit an instruction to create communication paths for implementing virtual links for connecting the first virtual node and the neighboring virtual nodes on physical links connecting the second physical node and the neighboring physical nodes;
a fourth step of creating, by the at least one link management unit, the communication paths for connecting the second physical node and the neighboring physical nodes on the physical links based on the instruction to create the communication paths;
a fifth step of starting, by the at least one node management unit, the service executed by the first virtual node using the computer resources secured by the second physical node;
a sixth step of sending, by the network management unit, the at least one link management unit an instruction to switch the virtual links; and
a seventh step of switching, by the at least one link management unit, communication paths to the created communication paths for switching the virtual links.

8. The method for migration of a virtual node according to claim 7,
wherein the at least one link management unit controls data transmission and reception between virtual nodes based on the path configuration information,
wherein, the fourth step includes:
a step of creating the communication paths configured so as to permit data transmission from the first virtual node allocated the computer resources of the second physical node to the neighboring virtual nodes and prohibit data transmission from the neighboring virtual nodes to the first virtual node allocated the computer resources of the second physical node; and
a step of adding configuration information associating identification information on the created communication paths with information indicating whether to permit data transmission to the path configuration information, and
wherein the seventh step includes a step of updating, upon receipt of the instruction to switch virtual links, the configuration information added to the path configuration information so as to permit data transmission from the neighboring virtual nodes to the first virtual node allocated the computer resources of the second physical node.

9. The method for migration of a virtual node according to claim 8, further comprising:
a step of sending, by the network management unit, the node management unit a requirement for stopping the service executed by the first virtual node allocated the computer resources of the first physical node,
a step of determining, by the node management unit, whether the received requirement for stopping the service is satisfied, and
a step of stopping, by the node management unit, the service executed by the first virtual node allocated the computer resources of the first physical node in a case of determination that the received requirement for stopping the service is satisfied.

10. The method for migration of a virtual node according to claim 9, wherein the requirement for stopping the service is reception of notices of completion of the switching of virtual links from the neighboring physical nodes.

11. The method for migration of a virtual node according to claim 10, further comprising a step of releasing, by the node management unit, the computer resources of the first physical node allocated to the first virtual node after stopping the service executed by the first virtual node allocated the computer resources of the first physical node.

12. The method for migration of a virtual node according to claim 8,
wherein each of the physical nodes includes the node management unit and the link management unit,
wherein the fourth step includes:
a step of creating, by the link management unit of the second physical node and the link management units of the neighboring physical nodes, the communication paths;
a step of adding, by the link management unit of the second physical node, first configuration information to permit data transmission and reception via the communication paths to the path configuration information;
a step of adding, by the link management units of the neighboring nodes, second configuration information to permit data reception via the communication paths and prohibit data transmission via the communication paths to the path configuration information; and
a step of sending, by the node management units of the neighboring physical nodes, the second physical node first control information indicating completion of the creating the communication paths via the created communication paths,
wherein the fifth step includes:
a step of allocating, by the node management unit of the second physical node which have received the first control information, the secured computer resources to the first virtual node to start the service executed by the first virtual node,
a step of sending, by the node management unit of the second physical node, the neighboring physical nodes second control information indicating the start of the service executed by the first virtual node via the communication paths, and
wherein the seventh step includes a step of changing, by the link management units of the neighboring physical nodes which have received the second control information, the second configuration information so as to permit data transmission via the communication paths to switch the virtual links.
